(19) United States
(12) Patent Application Publication
(10) Pub. No.: US 2003/0158723 A1
(43) Pub. Date: Aug. 21, 2003

(54) Syntactic information tagging support system and method

(75) Inventors: Hiroshi Masuichi, Ashigarakami-gun (JP); Tomoko Ohkuma, Ashigarakami-gun (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/368,445

(22) Filed: Feb. 20, 2003

(30) Foreign Application Priority Data
Feb. 20, 2002 (JP) 2002-043697

(51) Int. Cl. G06F 17/28

(52) U.S. Cl. 704/4

(57) ABSTRACT

A parsing section applies parsing processing to each of sentences, which is a target sentence and outputs parsing result candidates such as candidates of a modification relation of the sentence. A semantic analysis section performs semantic analysis processing on the target sentence and outputs semantic analysis result candidates such as candidates of a case frame of the sentence. A semantic analysis result determining section has a user interface for presenting the semantic analysis result candidates to a user so as to allow the user to select a correct semantic analysis result. A semantic analysis result is determined by the selection of the user. A parsing result determining section determines a parsing result based on the determined semantic analysis result and the analysis result information. A tagging section performs tagging with tags indicating syntactic information upon the target sentence on the basis of the determined parsing result.

The present disclosure relates to the subject matter contained in Japanese Patent Application No. 2002-43697 filed on Feb. 20, 2002, which is incorporated herein by reference in its entirety.

### BACKGROUND OF THE INVENTION

1. Field of the Invention

The present invention relates to a syntactic information tagging technique, which applies parsing processing to text by using a computer, adds operator's judgment to the result of the parsing processing so as to determine a final parsing result, and then adds the obtained syntactic information to the text in a form of tags. In addition, the invention relates to a sentence analysis technique used in such a syntactic information tagging technique.

2. Description of the Related Art

Parsing processing means processing, which receives a natural language sentence and determines modification relations among words according to grammatical rules. A parsing result is typically expressed as a tree structure called a syntax tree. FIG. 2 shows an example of a syntax tree obtained as a parsing result of the Japanese sentence “sekkyaku ni ataru koukousei ya furiitaa ni kotobadukai ya chumon no ukekata wo oshieru manuaru (tebikisho) ga sakunen natsu ookiku sugata wo kaeta.”—meaning “a manual (a guide book) which guides shop waiters such as high-school students or part-timers in how to talk and receive an order changed its style in the last summer drastically.” As shown in FIG. 2, each node in the tree structure is often assigned a name representing a partial structure following the interested node. For example, “NP (Noun Phrase)” in FIG. 2 shows that a partial structure following the interested node assigned the term is a noun phrase.

“Let's analyze example sentences”, Kentaro Inui and Kiyoaki Shirai, Information Processing, Vol. 41, No. 7, pp. 763-768 (2000), says the following three points in terms of the importance of parsing.

(1) Tobe a partial task essential to language understanding.

(2) To offer an important clue for evaluating a semantic analogy between sentences or between texts.

(3) To be useful as a tool for acquiring knowledge.

The point (1) may include applications relating to a dialog system, machine translation, document correction support, document summarization, and the like. The relationship between these applications and the parsing processing is described in detail in “Natural Language Processing” Makoto Nagao, Iwanami Shoten (1996), “Natural Language Processing—Fundamentals and Applications—” Hozumi Tanaka, The Institute of Electronics, Information and Communication Engineers (1999), and so on.

The point (2) relates to applications such as text retrieval, information filtering, document clustering, and question answering. Importance of parsing processing in these applications is described in “For a Sophisticated Parser” Kentaro Torisawa, Information Processing, Vol. 40, No. 4, pp. 380-386 (1999).

The point (3) relates to a manner to automatically or semiautomatically acquire large-scale knowledge required for natural language processing from electronic text. Acquisition of knowledge from language data, such as extraction of case frames of verbs, extraction of semantic classification of words, acquisition of translation knowledge, and acquisition of grammatical knowledge, is an urgent problem for raising the natural language processing technology to the level of practical use as described in “Natural Language Processing” Makoto Nagao, Iwanami Shoten (1996), and “Natural Language Processing—Fundamentals and Applications—” Hozumi Tanaka, The Institute of Electronics, Information and Communication Engineers (1999). The parsing processing also plays an important role in this point.

In such a manner, parsing is a technique playing an important role for realizing various applications. However, it is difficult to say that current parsing systems have not yet achieved sufficient analysis accuracy for realizing practical applications, as described in “Not So Bad, KNP” Sadao Kurohashi, Information Processing, Vol. 41, No. 11, pp. 1215-1220 (2000).

Under existing circumstances, the only solution to this problem is to manually correct a parsing result obtained by a parsing system. For example, a system for attaining machine translation or sentence summarization with extremely high accuracy by allotting to natural language sentences with tags (annotations) indicating syntactic information has been proposed in “Semantic Transcoding: Mechanism for Semantic Extension and Efficient Reuse of the Web” Katashi Nagao, Proceedings of the 15th AI Symposium, pp. 7-13 (2001). The tags here are expressed in XML (eXtensible Markup Language), adopting a description format called GDA (Global Document Annotation). The proposal in this document premises that any sentence is tagged with only correct syntactic information. However, it is impossible to always obtain a correct parsing result by use of the existing parsing technology as described above. Therefore, tagging with syntactic information has to be performed by entirely manually tagging with syntactic information or by manually editing a parsing result obtained from a parsing system so as to obtain a correct result.

According to such a manner to tag with syntactic information, machine translation, document summarization, voice synthesis, finding of knowledge from a set of documents, and so on, can be attained with extremely high accuracy as described in “Semantic Transcoding: Mechanism for Semantic Extension and Efficient Reuse of the Web” Katashi Nagao, Proceedings of the 15th AI Symposium, pp. 7-13 (2001). However, the high cost of manual tagging is a problem of this method. FIG. 3 shows an example of a sentence tagged with XML tags as syntactic information, the example being quoted from “Semantic Transcoding: Mechanism for Semantic Extension and Efficient Reuse of the Web” Katashi Nagao, Proceedings of the 15th AI Symposium, pp. 7-13 (2001). It is actually impossible to carry out such tagging manually upon a large volume of text. However, if a correct syntax tree is obtained, a correct syntax system to be automatic tagging can be performed easily on the basis of the correct syntax tree. In fact, therefore, the following manner has been adopted. That is, a syntax tree obtained as a maximum probable parsing result from a parsing system is presented to a user, and tagging is semiautomated using a user interface in which the user can correct erroneous parts of the tree structure, so that reduction in cost can be achieved. For example, one of documents in which such manners have been proposed is JP-A-2001-51998 “Japanese Document Making Apparatus”.

However, a syntax tree has a complicated structure as shown in FIG. 2. For all but those who are not skilled in linguistics, it is difficult to understand the meanings of terms assigned to nodes and judge whether the syntax tree is correct or not. Therefore, only those who are skilled in linguistics can perform the work of constantly correctly tagging with tags indicating syntactic information. It can be therefore said that even if a syntax tree is presented in support, there still is the difficulty of finding a person of required talent so that tagging on a large volume of text remains difficult. Further, even for those who are skilled in linguistics, it is not an easy work to find erroneous parts and correct them, meaning that it still takes very much time and cost for the work.

### SUMMARY OF THE INVENTION

The invention has been developed in consideration of such problems. It is an object of the invention to provide a syntactic information tagging support technique having a user interface with which even those who are not skilled in linguistics can perform tagging with syntactic information easily.

According to an aspect of the invention, there is provided a syntactic information tagging support system including an analysis target sentence retaining section for retaining a target sentence for parsing, a parsing section for performing parsing processing on the sentence retained by the analysis target sentence retaining section to output parsing result candidates, a semantic analysis section for performing semantic analysis processing on the sentence retained by the analysis target sentence retaining section to output semantic analysis result candidates, an analysis result retaining section for retaining analysis result information including the parsing result candidates, the semantic analysis result candidates, and correspondence relations between the parsing result candidates and the semantic analysis result candidates, a semantic analysis result determination section for determining a correct semantic analysis result by use of user interface for presenting the semantic analysis result candidates to a user so as to allow the user to select the correct semantic analysis result, a parsing result determination section for determining a parsing result based on the determined semantic analysis result and the analysis result information retained by the analysis result retaining section, and a tagging section for performing tagging with tags indicating syntactic information upon the sentence retained by the analysis target sentence retaining section based on the determined parsing result.

Incidentally, the “tag” used herein means auxiliary information to be added to a sentence in order to indicate syntactic information. The tag is also referred to as an annotation. Such auxiliary information is included in the “tag”, whatever its appellation is.

The parsing section processing for determining modification relation between words in a sentence as described previously. On the other hand, the semantic analysis includes processing for determining case information in the sentence.

The concepts of subject, object and predicate obtained by semantic analysis can be understood in common sense by those who have not learned linguistics. The work of correcting such a semantic analysis result is easier than the work of correcting a parsing result. According to the invention, semantic analysis result candidates are presented to a system user and corrected by the system user so that a correct semantic analysis result is acquired, and a parsing result is determined based on the obtained semantic analysis result. Thus, it is possible to construct a syntactic information tagging support system, which can tag a sentence with correct tags indicating syntactic information. Accordingly, for those who are not skilled in linguistics, it is possible to perform tagging with correct syntactic information at lower cost than in the related art.

The aforementioned aspect and other aspects of the invention will be described below in detail by use of its embodiments.

Incidentally, the invention can be carried out not only in the form of an apparatus or a system but also in the form of a method. Further, the invention can be carried out at least partially in the form of a computer program.

### BRIEF DESCRIPTION OF THE DRAWINGS

FIG. 1 shows a configuration of a typical syntactic information tagging support system according to the invention.

FIG. 2 is a diagram showing an example of a parsing result (syntax tree).

FIG. 3 is a view showing an example of text to which a parsing result has been added in the form of tags.

FIG. 4 is a diagram showing a configuration of an embodiment of the invention.

FIG. 5 is a diagram showing a parsing result candidate in the embodiment.

FIG. 6 is a diagram showing a parsing result candidate in the embodiment.

FIG. 7 is a diagram showing a parsing result candidate in the embodiment.

FIG. 8 is a diagram showing a parsing result candidate in the embodiment.

FIG. 9 is a diagram showing a parsing result candidate in the embodiment.

FIG. 10 is a diagram showing a parsing result candidate in the embodiment.

FIG. 11 is a diagram showing a parsing result candidate in the embodiment.

FIG. 12 is a diagram showing a parsing result candidate in the embodiment.

FIG. 13 is a diagram showing a parsing result candidate in the embodiment.

FIG. 14 is a diagram showing a semantic analysis result candidate in the embodiment.

FIG. 15 is a diagram showing a semantic analysis result candidate in the embodiment.

FIG. 16 is a diagram showing a semantic analysis result candidate in the embodiment.

FIG. 17 is a diagram showing a semantic analysis result candidate in the embodiment.

FIG. 18 is a diagram showing a semantic analysis result candidate in the embodiment.

FIG. 19 is a diagram showing a semantic analysis result candidate in the embodiment.

FIG. 20 is a diagram showing a semantic analysis result candidate in the embodiment.

FIG. 21 is a diagram showing a semantic analysis result candidate in the embodiment.

FIG. 22 is a diagram showing a semantic analysis result candidate in the embodiment.

FIG. 23 is a conceptual view showing a procedure of case frame acquisition in the embodiment.

FIG. 24 is a conceptual view showing a procedure of case element acquisition in the embodiment.

FIG. 25 is a conceptual view showing a procedure of non-case element acquisition in the embodiment.

FIG. 26 is a table showing a relationship between predicates and analysis result candidates in the embodiment.

FIG. 27 is a table showing a relationship between case frame and analysis result candidates in the embodiment.

FIG. 28 is a table showing a relationship between case elements and analysis result candidates in the embodiment.

FIG. 29 is a table showing a relationship between non-case elements and analysis result candidates in the embodiment.

FIG. 30 is a flow chart showing a procedure of processing in a semantic analysis result determining section.

FIG. 31 is a view showing an example of an interface of the semantic analysis result determining section.

FIG. 32 is a view showing an example of an interface of the semantic analysis result determining section.

FIG. 33 is a table showing the relationship between case elements and analysis result candidates in the embodiment.

FIG. 34 is a view showing an example of an interface of the semantic analysis result determining section.

FIG. 35 is a view showing an example of an interface of the semantic analysis result determining section.

FIG. 36 is a diagram showing a parsing result in the embodiment.

FIG. 37 is a view showing an example of an interface of the semantic analysis result determining section.

FIG. 38 is a table showing the relationship between case elements and analysis result candidates in the embodiment.

FIG. 39 is a view showing an example of an interface of the semantic analysis result determining section.

FIG. 40 is a view showing an example of an interface of the semantic analysis result determining section.

FIG. 41 is a diagram showing a parsing result candidate in the embodiment.

FIG. 42 is a diagram showing a parsing result candidate in the embodiment.

FIG. 43 is a diagram showing a parsing result candidate in the embodiment.

FIG. 44 is a diagram showing a semantic analysis result candidate in the embodiment.

FIG. 45 is a diagram showing a semantic analysis result candidate in the embodiment.

FIG. 46 is a diagram showing a semantic analysis result candidate in the embodiment.

FIG. 47 is a table showing the relationship between case frame and analysis result candidates in the embodiment.

FIG. 48 is a view showing an example of an interface of the semantic analysis result determining section.

FIG. 49 is a diagram showing a parsing result candidate in the embodiment.

FIG. 50 is a diagram showing a parsing result candidate in the embodiment.

FIG. 51 is a diagram showing a parsing result candidate in the embodiment.

FIG. 52 is a diagram showing a parsing result candidate in the embodiment.

FIG. 53 is a diagram showing a semantic analysis result candidate in the embodiment.

FIG. 54 is a diagram showing a semantic analysis result candidate in the embodiment.

FIG. 55 is a diagram showing a semantic analysis result candidate in the embodiment.

FIG. 56 is a diagram showing a semantic analysis result candidate in the embodiment.

FIG. 57 is a table showing the relationship between case elements and analysis result candidates in the embodiment.

FIG. 58 is a view showing an example of an interface of the semantic analysis result determining section.

FIG. 59 is a view showing an example of a case frame description.

FIG. 60 is a diagram showing an example of an application form of a syntactic information tagging support system according to the invention.

FIG. 61 is a diagram showing an example of an application form of a syntactic information tagging support system according to the invention.

FIG. 62 is diagrams showing parsing result candidates in the embodiment.

FIG. 63 is a table showing a relationship between predicates and analysis result candidates in the embodiment.

FIG. 64 showing a semantic analysis result candidate in the embodiment.

FIG. 65 showing a semantic analysis result candidate in the embodiment.

FIG. 66 showing a semantic analysis result candidate in the embodiment.

FIG. 67 showing a semantic analysis result candidate in the embodiment.

FIG. 68 is a view showing an example of an interface of the semantic analysis result determining section.

FIG. 69 is a view showing an example of an interface of the semantic analysis result determining section.

### DETAILED DESCRIPTION OF THE PREFERRED EMBODIMENTS

First, description will be made on the theoretical configuration of the invention.

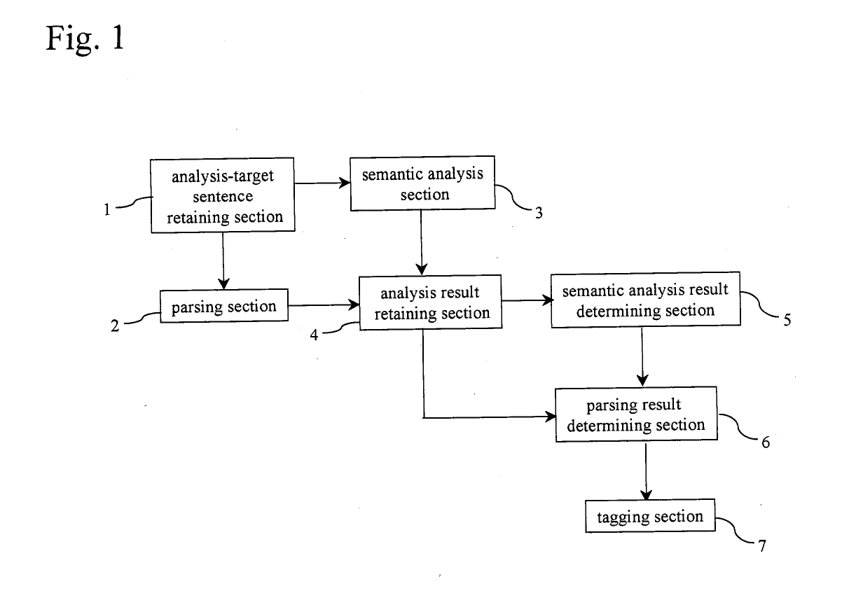

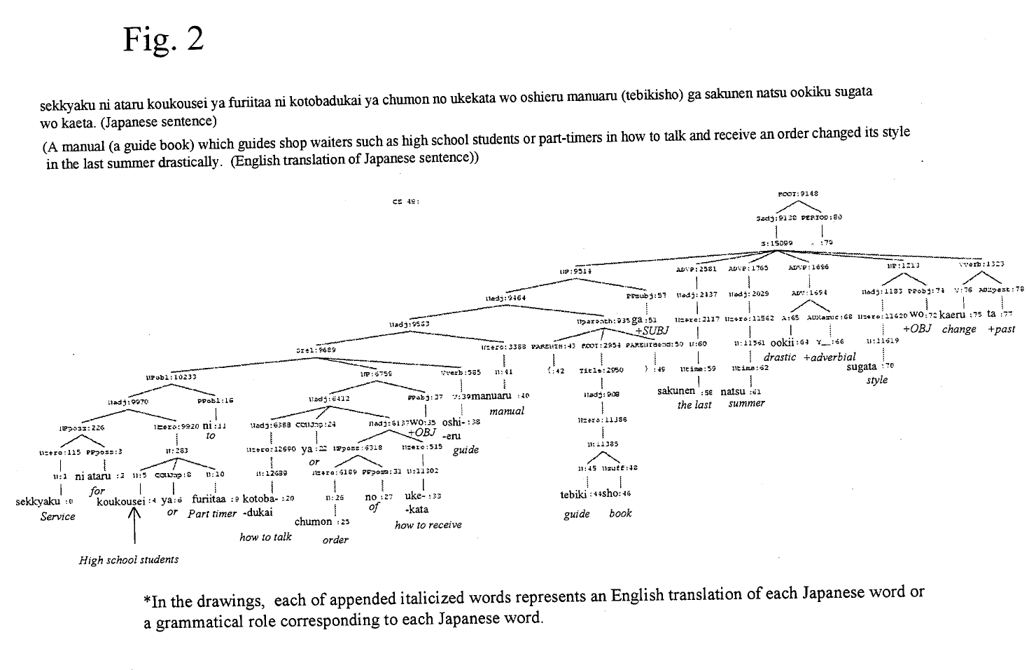

FIG. 1 shows a syntactic information tagging support system adopting the theoretical configuration of the invention. In FIG. 1, the syntactic information tagging support system includes an analysis-target sentence retaining section 1, a parsing section 2, a semantic analysis section 3, an analysis result retaining section 4, a semantic analysis result determining section 5, a parsing result determining section 6 and a tagging section 7.

The analysis-target sentence retaining section 1 retains a target sentence for parsing. The parsing section 2 applies parsing processing to each of sentences retained by the analysis-target sentence retaining section 1, and outputs parsing result candidates such as candidates of a modification relation of the sentence. The semantic analysis section 3 performs semantic analysis processing on each of sentences retained by the analysis-target sentence retaining section 1, and outputs semantic analysis result candidates such as candidates of a case frame of the sentence. The analysis result retaining section 4 retains analysis result information including the parsing result candidates, the semantic analysis result candidates, and correspondence relations between the both. The semantic analysis result determining section 5 has a user interface for presenting the semantic analysis result candidates to a user so as to allow the user to select a correct semantic analysis result. A semantic analysis result is determined by the selection of the user. The parsing result determining section 6 determines a parsing result based on the determined semantic analysis result and the analysis result information retained by the analysis result retaining section 4. The tagging section 7 performs tagging with tags indicating syntactic information upon each of sentences retained by the analysis-target sentence retaining section 1 on the basis of the determined parsing result.

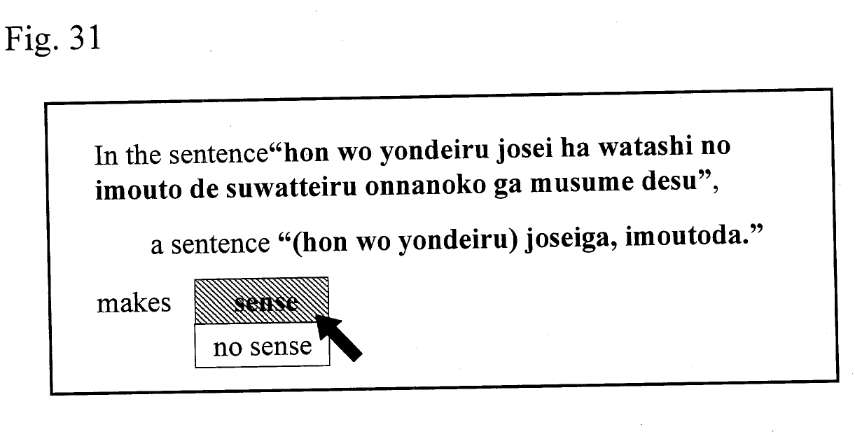

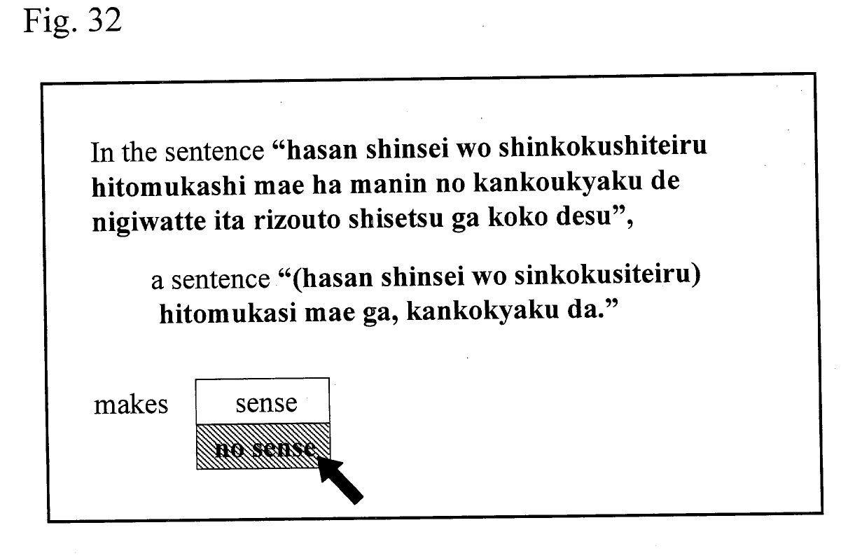

For example, the semantic analysis result determining section 5 presents to a user a user interface as shown in FIG. 31 or 32 that will be described later, so as to disambiguate meaning. The interface is not concerned with syntactic information but concerned with semantic information. It is therefore possible for the user to operate the user interface naturally and easily.

The syntactic information tagging support system can be executed by a computer 100 such as a personal computer, and can output tagged sentences to the outside through a tagged sentence output section 8. The output tagged sentences can be recorded in various recording media 9 (hard disk, portable recording disk, and the like). In addition, the tagged sentences can be translated by a machine translation section 10.

Next, the invention will be further described by use of a more specific embodiment.

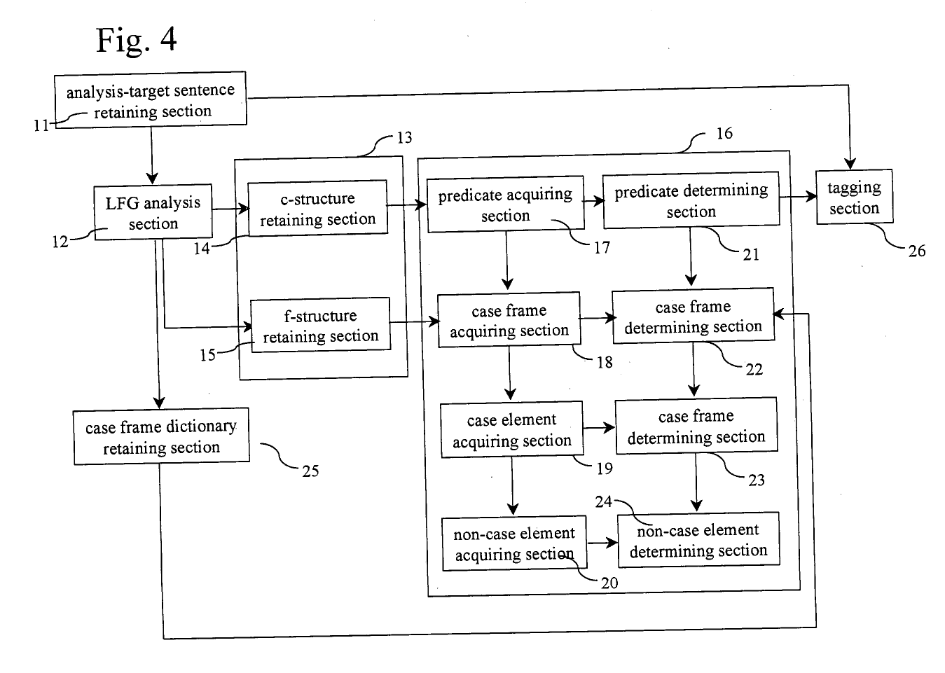

FIG. 4 shows a configuration of a syntactic information tagging support system according to an embodiment of the invention. In this embodiment, case information based on the classification by grammatical roles is used. Incidentally, in some embodiments, although parsing and semantic analysis are applied to sentences written in Japanese, the description is made in English based on the English translation of the sentences. In addition, although the some embodiments will be described on a case where Japanese sentences is used as a target, similar effect can be obtained in any language so long as it is a language to which parsing processing and semantic analysis processing can be applied. Furthermore, it is assumed that parsing and semantic analysis in this embodiment are based on a grammatical theory called LFG (Lexical Functional Grammar) whose detailed contents are described in “A Grammar Writer's Cookbook”, Miriam Butt, Tracy Holloway King, Maria-Engenia Nino and Frederique Segond, CSLI publications, Stanford University (1999). However, it is apparent that similar effect can be obtained by use of parsing and semantic analysis using other grammatical theories.

In FIG. 4, the syntactic information tagging support system according to this embodiment includes an analysis-target sentence retaining section 11, a LFG analysis section 12, an analysis result retaining section 13, a semantic analysis result determining section 16 and a tagging section 26.

The analysis-target sentence retaining section 11 retains a plurality of sentences inside a computer.

The LFG analysis section 12 executes analysis based on the LFG theory upon each of sentences retained in the analysis-target sentence retaining section 11 as a target of analysis. According to the analysis based on the LFG theory, as described in the aforementioned literature “A Grammar Writer's Cookbook”, Miriam Butt, Tracy Holloway King, Maria-Engenia Nino and Frederique Segond, CSLI publications, Stanford University (1999), it is possible to obtain a tree structure showing a syntax tree called a c-structure as a result of parsing, and a list structure called an f-structure showing a case frame as a result of semantic analysis, respectively. In addition, to execute the LFG analysis, it is essential to refer to a case frame dictionary retained in a case frame dictionary retaining section 25. The same literature offers detail descriptions of the c-structure, the f-structure and the analyzing manner.. The LFG analysis section 12 constitutes the parsing section 2 and the semantic analysis section 3 in FIG. 1.

The analysis result retaining section 13 is constituted by a c-structure retaining section 14 and a f-structure retaining section 15. The c-structure retaining section 14 and the f-structure retaining section 15 retain c-structures and f-structures obtained from the LFG analysis section 12, in the inside of the computer for every sentence, respectively. Generally, natural language sentences contain syntactic/semantic ambiguity so that a plurality of c-structures and a plurality of f-structures are obtained as analysis result candidates from one sentence.

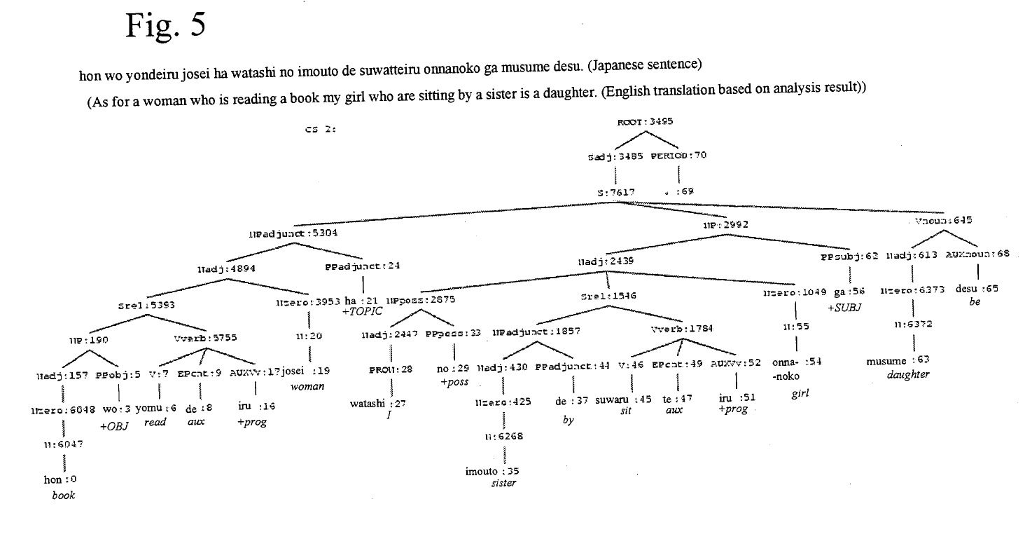

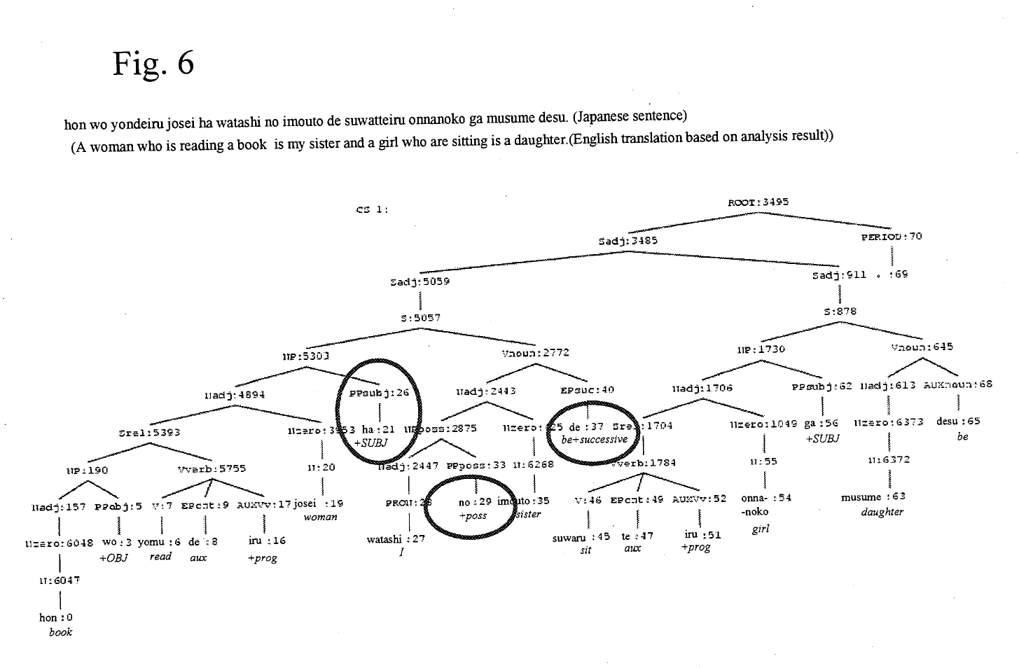

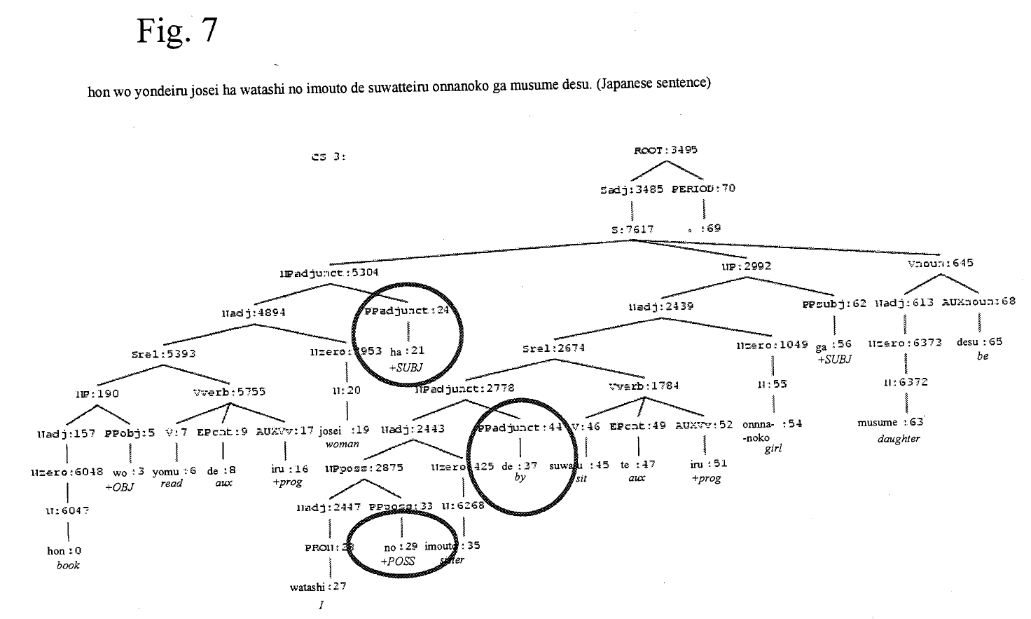

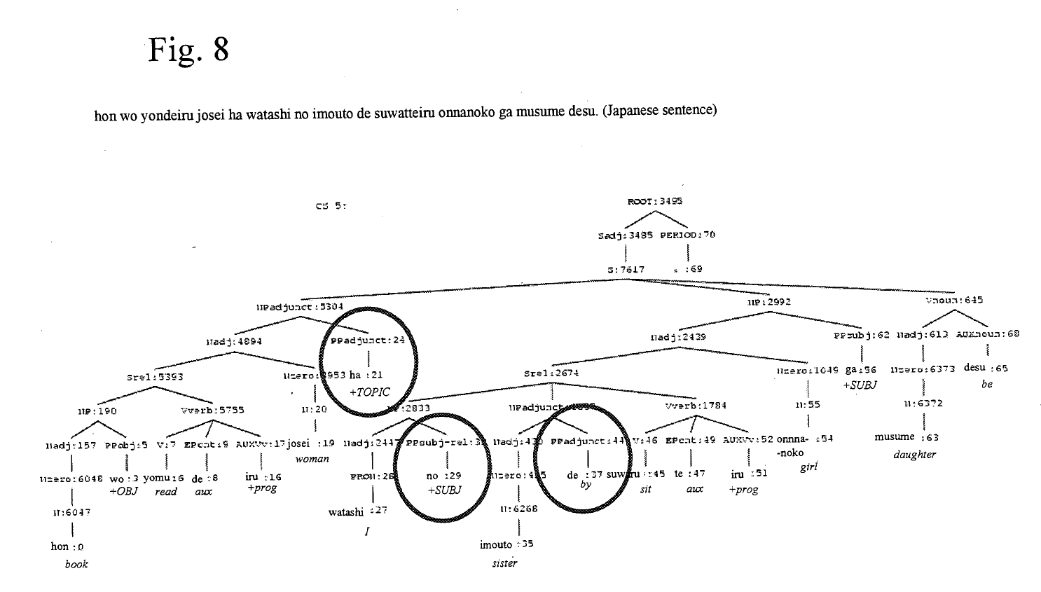

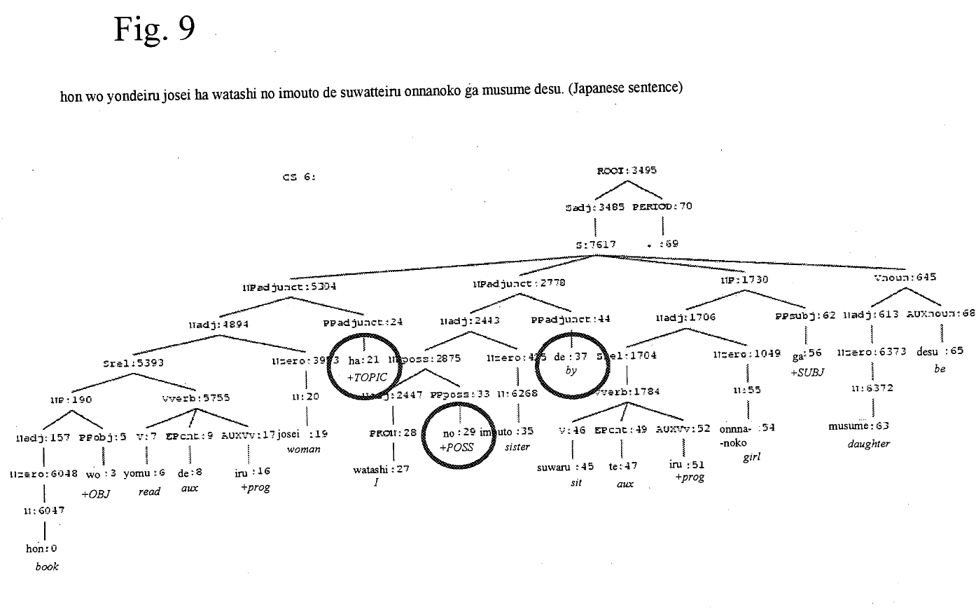

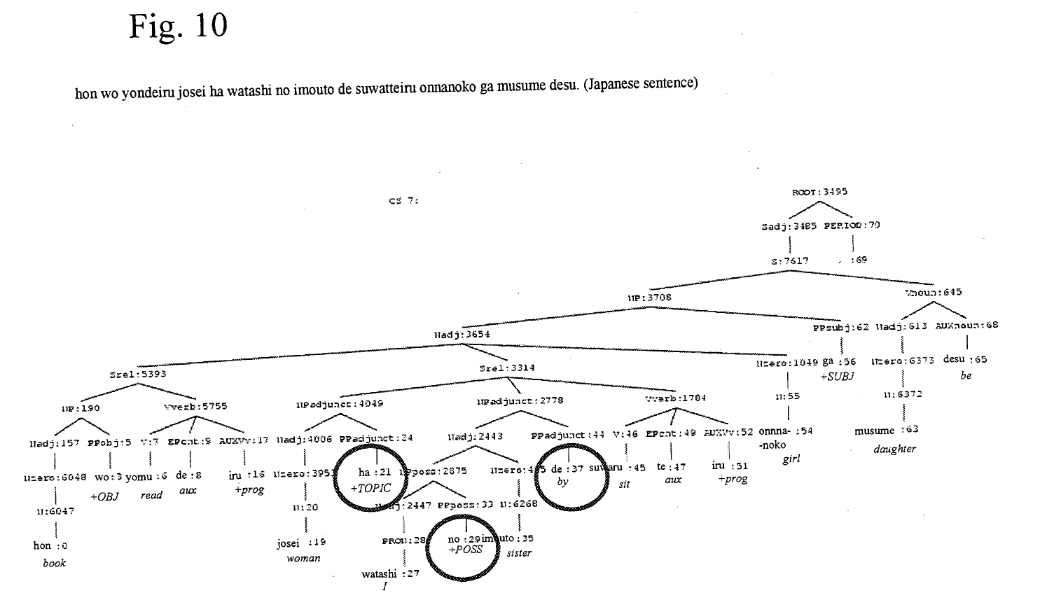

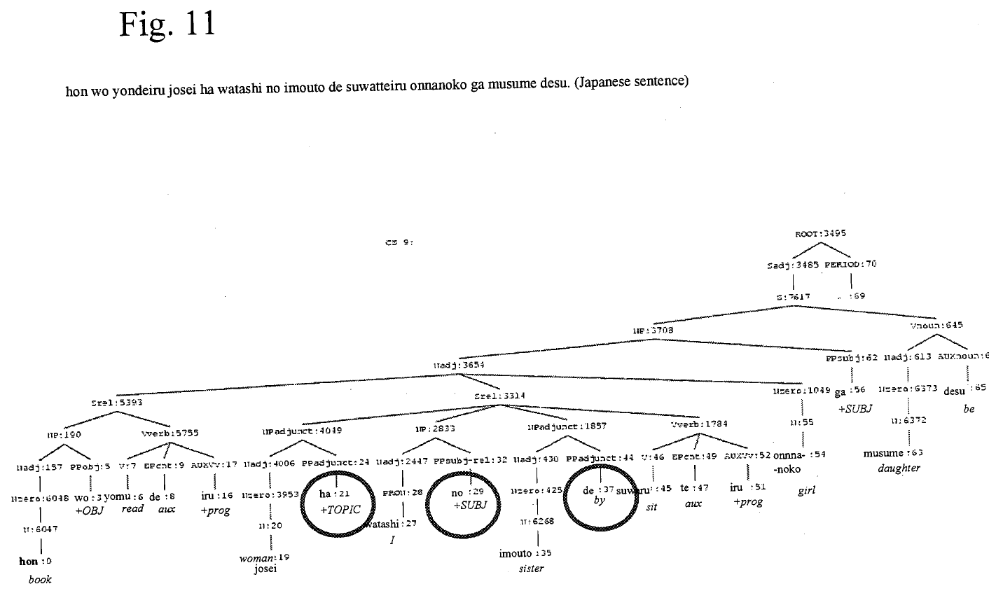

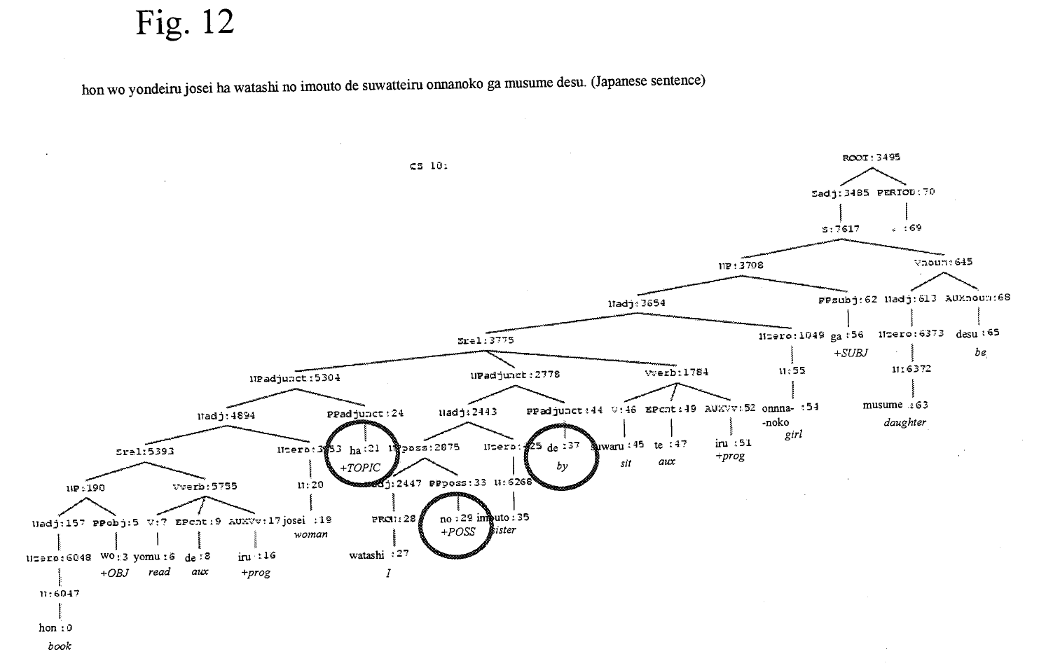

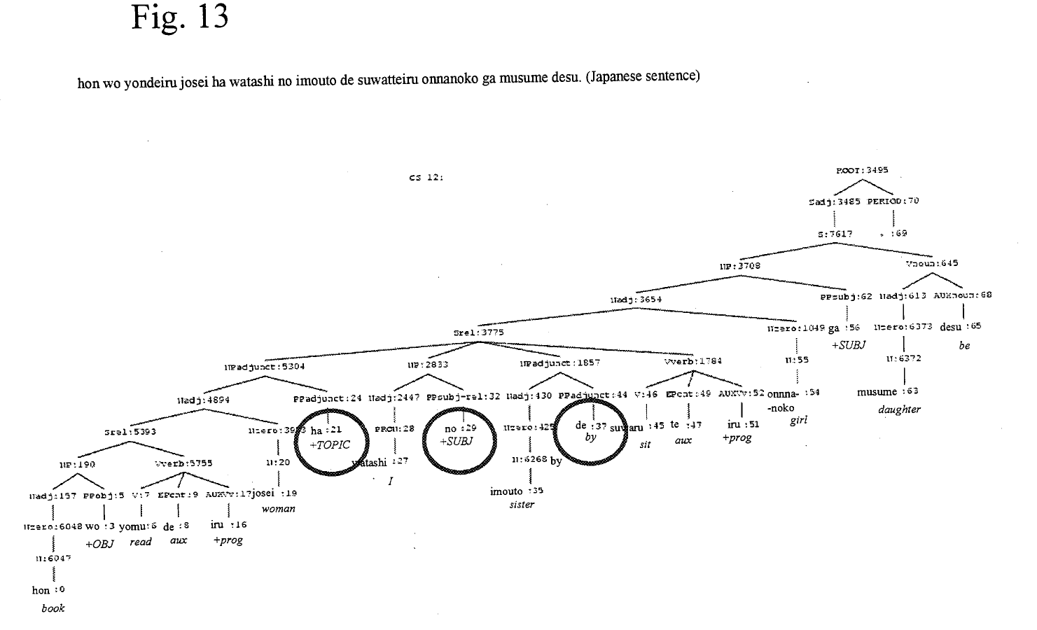

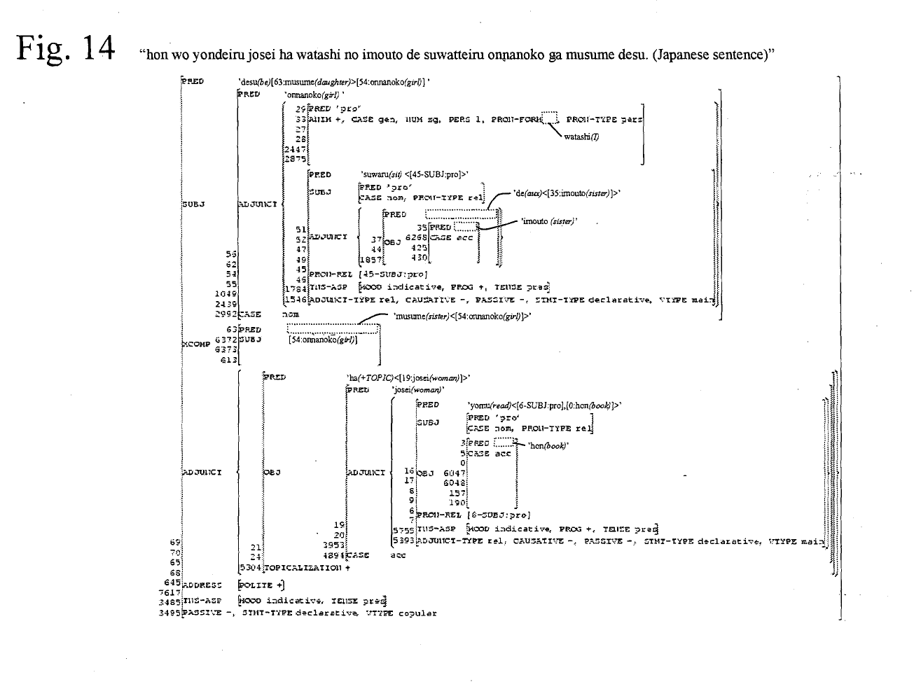

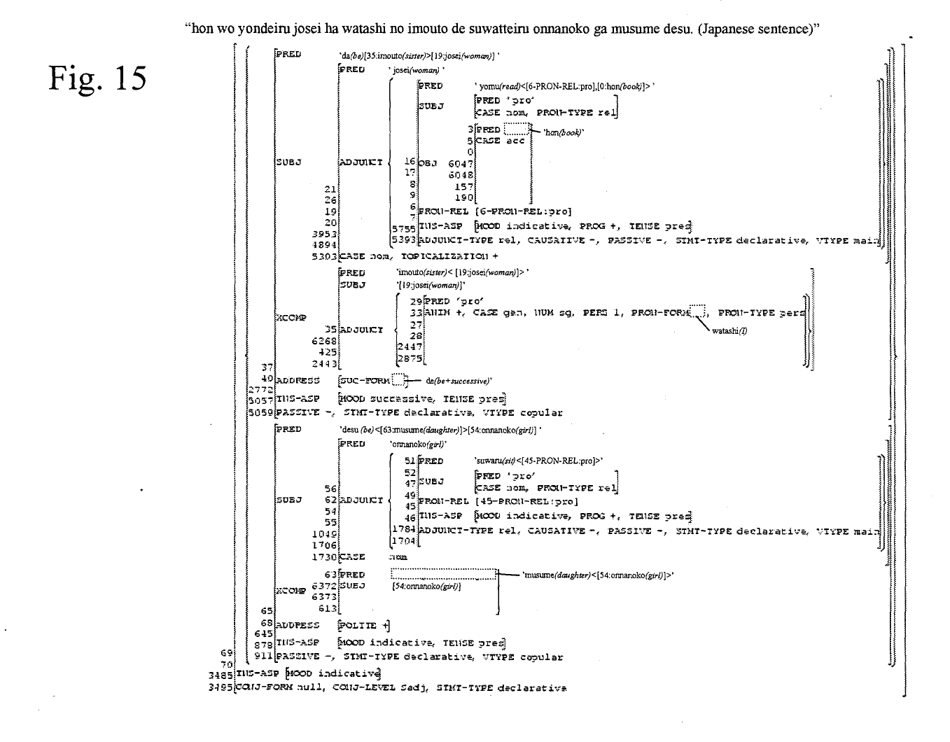

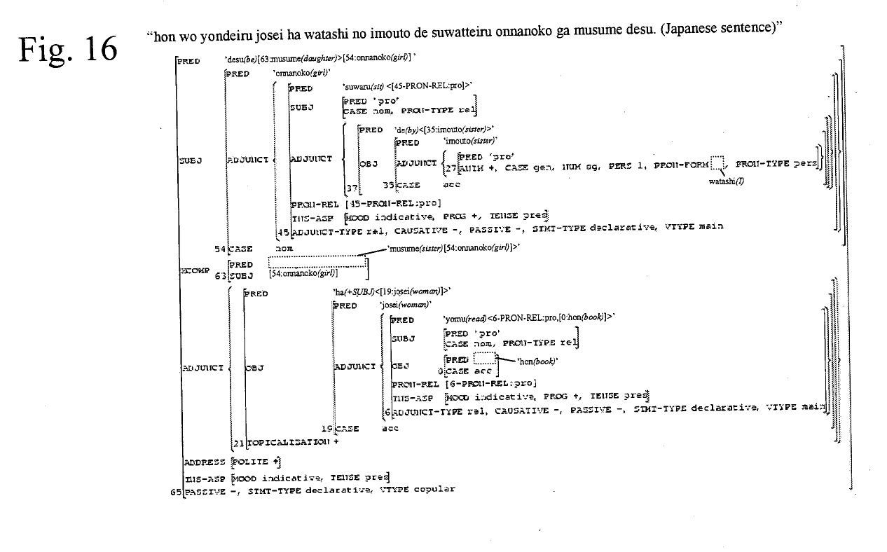

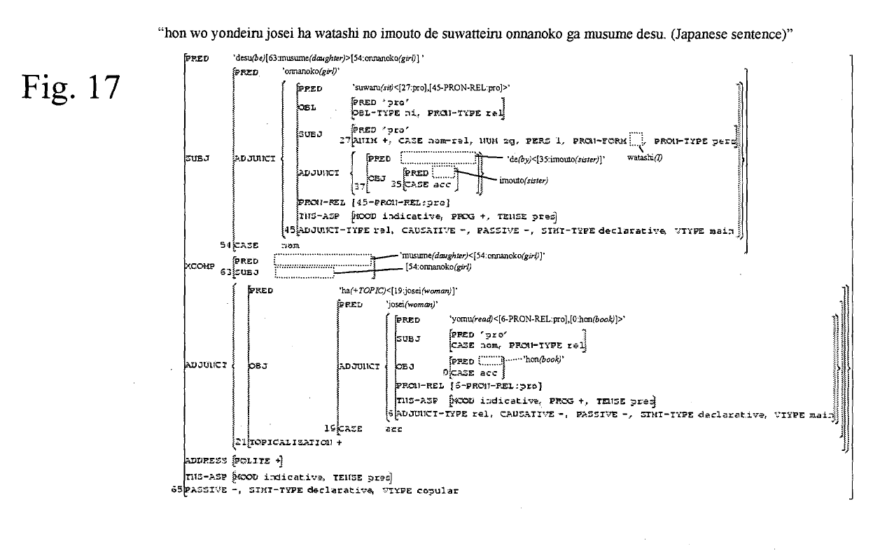

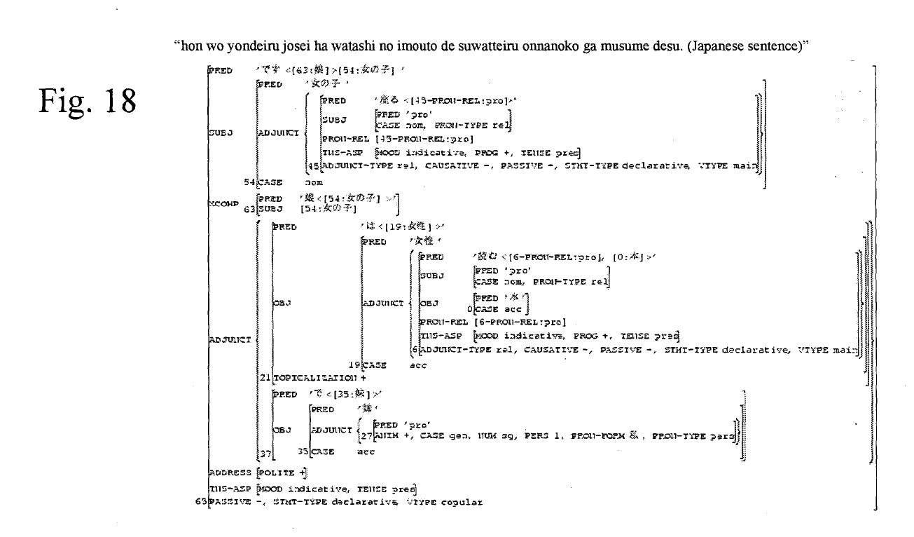

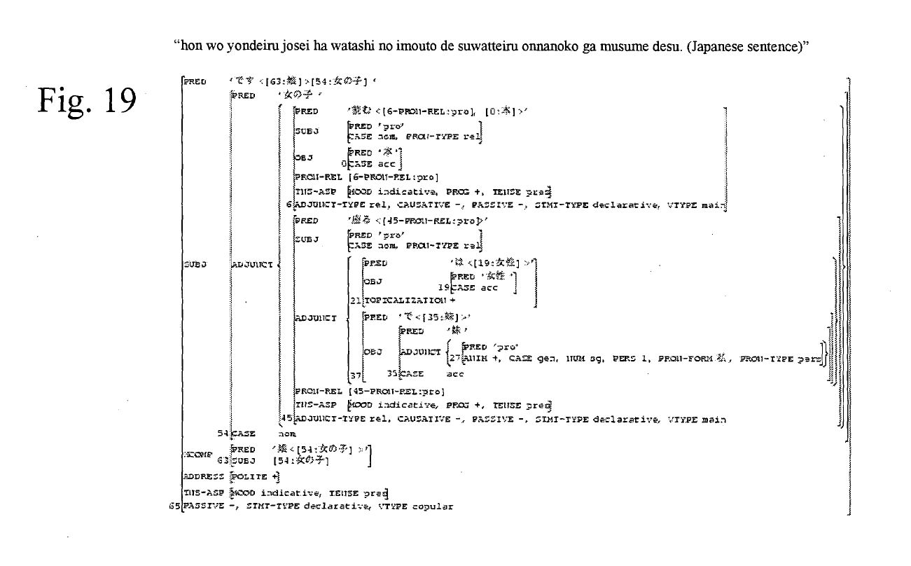

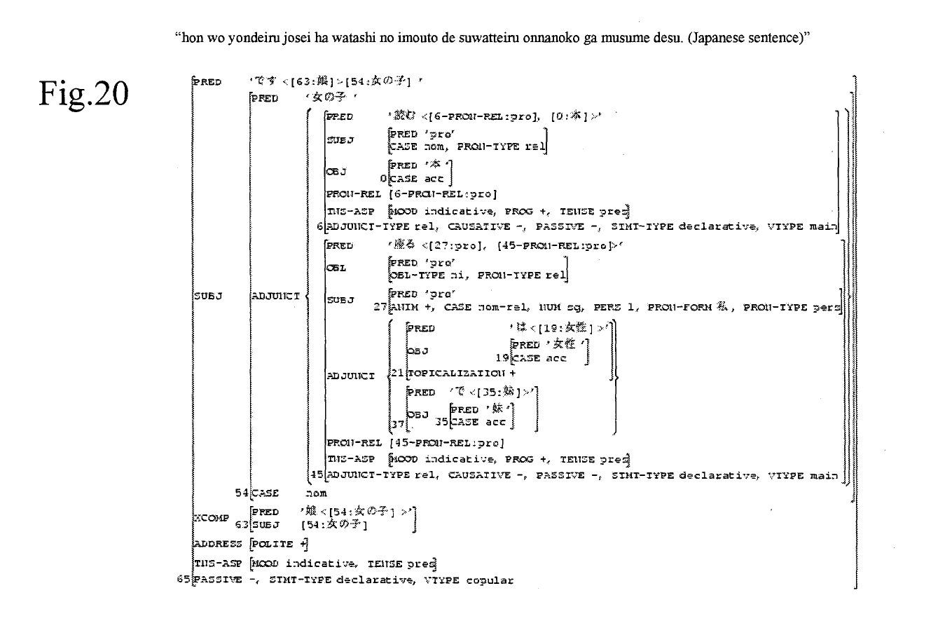

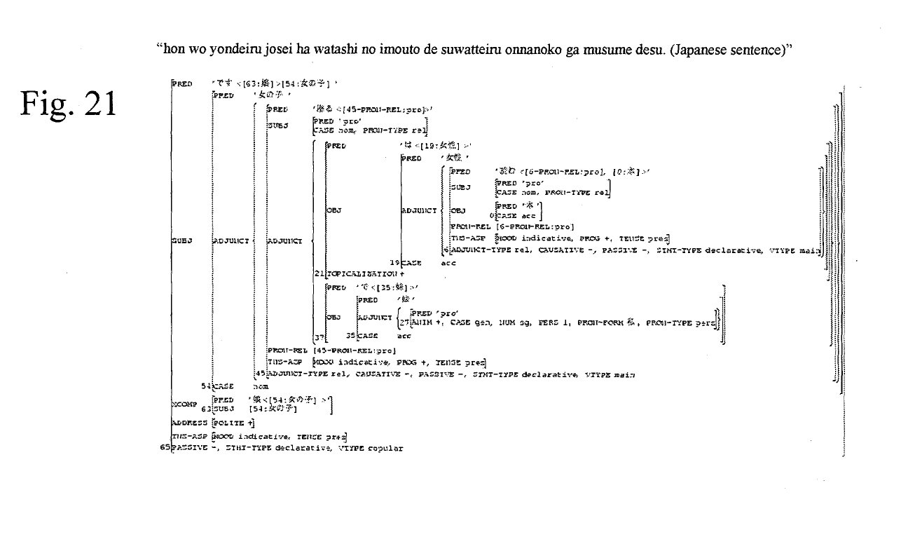

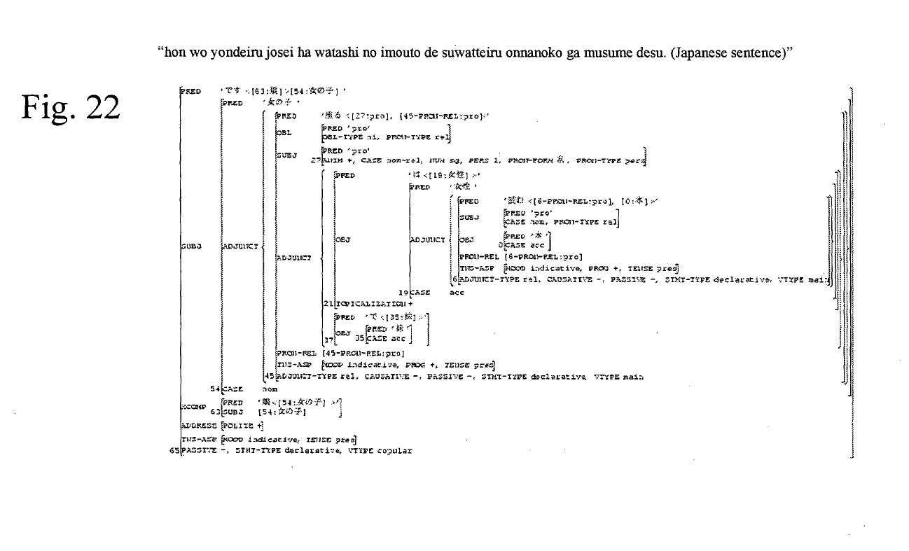

FIGS. 5 to 13 show c-structures obtained as parsing result candidates in the case of a Japanese sentence “hon wo yondeiru josei ha watashi no imouto de suwatteiru onnanoko ga musume desu.”—meaning “A woman who is reading a book is my sister and a girl who is sitting is a daughter.”—as a target of parsing. In this case, the parsing result has ambiguity of nine kinds corresponding to FIGS. 5 to 13. On the other hand, FIGS. 14 to 22 show f-structures obtained as semantic analysis result candidates in the case where the same sentence is used as a target of semantic analysis. FIG. 14 shows a semantic analysis result candidate corresponding to the parsing result candidate shown in FIG. 5, and FIG. 15 shows a semantic analysis result candidate corresponding to the parsing result candidate shown in FIG. 6. Similarly, FIGS. 16 to 22 show semantic analysis result candidates corresponding to the parsing result candidates shown in FIGS. 7 to 13, respectively.

Further, each node in a c-structure (tree structure) corresponds to each list (portion put between “[” and “]”) in a f-structure. For example, the node having an identifier “2992” and having a label “NP” in FIG. 5 means corresponding to the list having the same identifier “2992” and having a list name “SUBJ (subject)” in FIG. 14. Incidentally, parts of identifiers are omitted in FIGS. 16 to 22.

In addition, each c-structure retained in the c-structure retaining section 14 constructs a tree structure using a word as minimum unit. Conjugated words are retained in their canonical forms, while their corresponding character strings (surface form) in the sentence, which is a target of analysis, are retained together. For example, “yon” (a surface form (conjugated form) of “read” followed by auxiliary verbs) and “suwat” (a surface form (conjugated form) of “sit” followed by auxiliary verbs) are retained together with “yomu (read)” and “suwaru (sit)” in FIG. 5.

The semantic analysis result determining section 16 includes a predicate acquiring section 17, a case frame acquiring section 18, a case element acquiring section 19, a non-case element acquiring section 20, a predicate determining section 21, a case frame determining section 22, a case element determining section 23 and a non-case element determining section 24.

The predicate acquiring section 17 acquires identifiers of nodes corresponding to predicates of a sentence, which is a target of analysis, and character strings corresponding to the nodes, from a c-structure retained in the c-structure retaining section 14. In the examples of c-structures shown in FIGS. 5 to 13, nodes having a label “Vverb” or a label “Vnoun” correspond to predicates. For example, from the c-structure shown in FIG. 5, identifiers “5755” and “1784” are acquired as identifiers corresponding to “Vverb”, and an identifier “645” is acquired as an identifier corresponding to “Vnoun”. In addition, surface forms “yondeiru (is reading)”, “suwatteiru (is sitting)”, and “musumedesu (is a daughter)” corresponding to those identifiers are acquired, respectively. The label “Vverb” designates a predicate mainly composed of a verb, while the label “Vnoun” designates a predicate such as “musumedesu (is a daughter)” composed of a noun with “da”, “desu” or the like (a noun followed by auxiliary verbs). Generally, labels designating predicates other than “Vverb” and “Vnoun” include “Vadjective” designating a predicate mainly composed of an adjective and “Vadjectiveverb” designating a predicate mainly composed of an adjective verb.

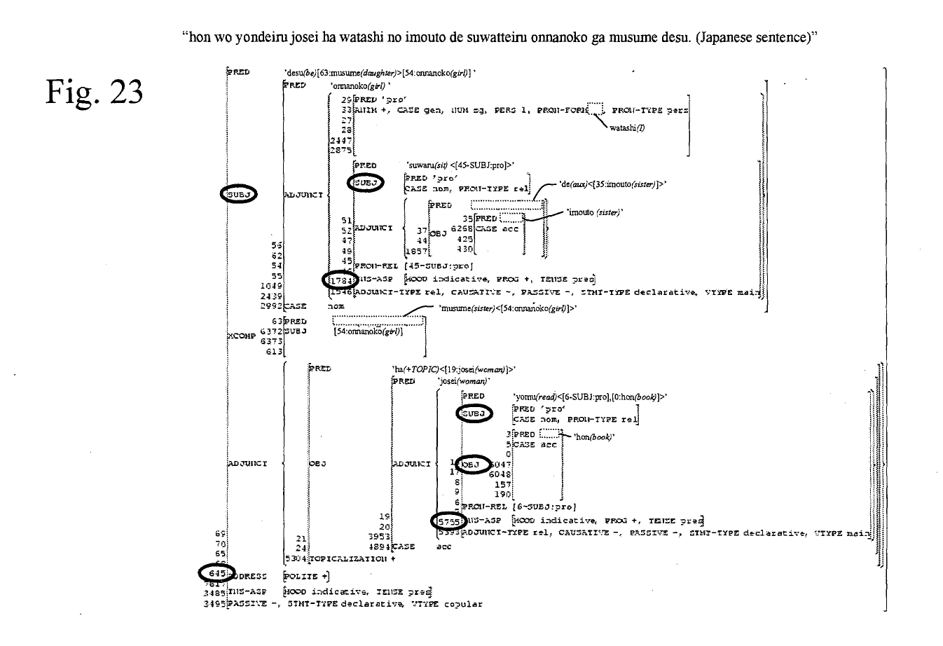

The case frame acquiring section 18 receives node identifiers corresponding to predicates acquired by the predicate acquiring section 17, and acquires case frames of the predicates with reference to the lists in the corresponding f-structure in the f-structure retaining section 15. For example, for the node identifiers “5755”, “1784” and “645” obtained from FIG. 5, case frames of the predicates are acquired with reference to the lists to which the identifiers “5755”, “1784”, and “645” allocated, in FIG. 14. As shown in FIG. 23 (the same f-structure as FIG. 14), only “SUBJ” exists as a case element in the list having the identifier “645”. Likewise, only “SUBJ” exists in the list having the identifier “1784”. On the other hand, “SUBJ” and “OBJ (object)” exist in the list having the identifier “5755”. Accordingly, from the semantic analysis result candidate corresponding to FIG. 14, case frames “subject-musumedesu (subject-is a daughter)” “subject-suwatteiru (subject-is sitting)” and “subject-object-yondeiru (subject-object-is reading)” can be obtained. Such case frame acquisition is carried out upon all the analysis result candidates retained in the analysis result retaining section 13. Incidentally, actual case elements include not only “SUBJ” and “OBJ” but also what is expressed as a grammatical role “OBLIQUE” in LFG, such as an instrumental case (“-de” meaning “by”) or a source (“-kara” meaning “from”).

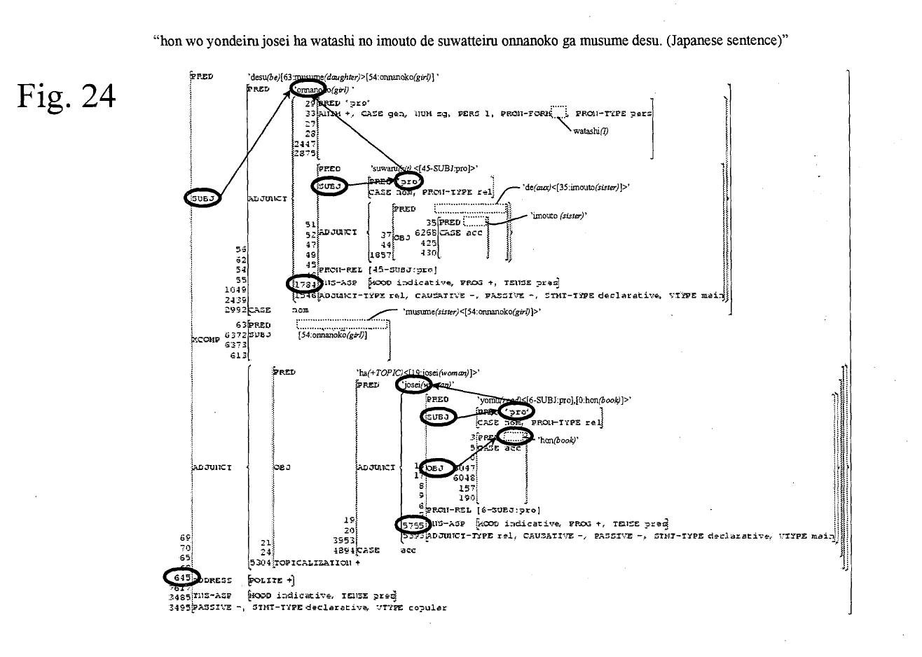

The case element acquiring section 19 acquires substances (words) of case elements acquired by the case frame acquiring section 18 with reference to the f-structure retained by the f-structure retaining section 15. This processing can be attained by referring to words corresponding to “PRED” in the lists corresponding to the case elements (SUBJ, OBJ, etc.) in the f-structure. (Incidentally, when a predicate is included in a relative clause, a destination where the relative clause modifies is referred to. The list name of a relative clause in an f-structure is “ADJUNCT” and a relative clause corresponds to a list including a description whose “ADJUNCT-TYPE” is “rel”.) For example, as shown in FIG. 24 (the same f-structure as FIG. 14), from the semantic analysis result candidate corresponding to FIG. 14, “onnanoko (girl)” is acquired as a subject of “musumedesu (is a daughter)”; “onnanoko (girl)” is acquired as a subject of “suwatteiru (is sitting)”; “josei (woman)” is acquired as a subject of “yondeiru (is reading)”; and “hon (book)” is acquired as an object of “yondeiru (is reading)”. Such case element acquisition is carried out upon all the analysis result candidates retained by the analysis result retaining section 13.

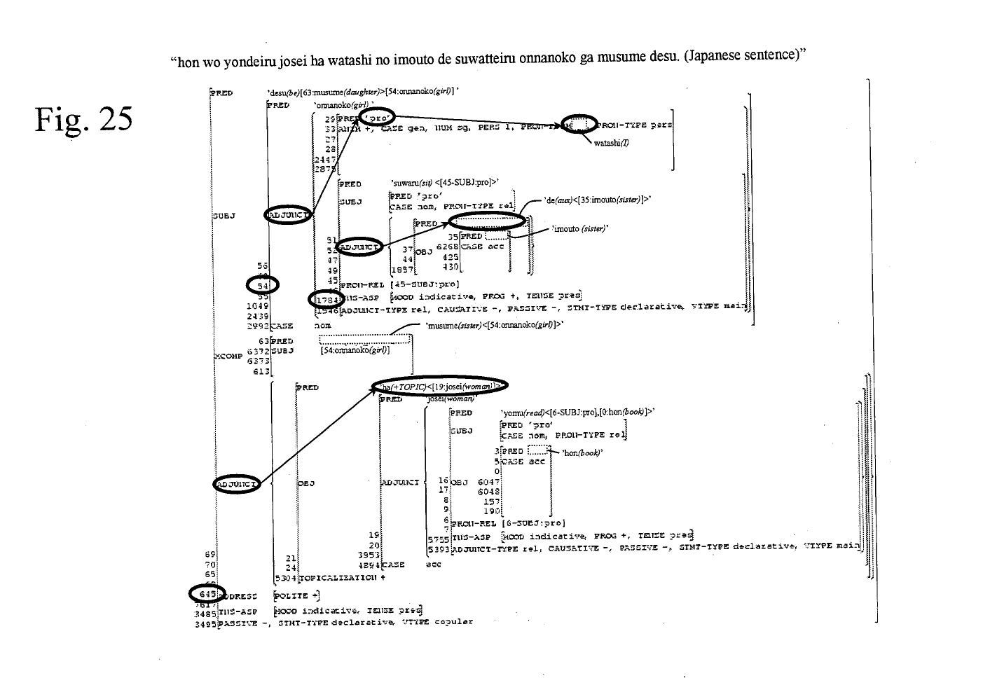

The non-case element acquiring section 20 acquires identifiers of phrasal modifiers (words) other than case elements and identifiers of destinations of the phrasal modifiers with reference to the f-structure retained by the f-structure retaining section 15. In LFG, phrasal modifiers other than case elements are expressed as a grammatical role, which is “ADJUNCT”. Incidentally, relative clauses have been already acquired by the case element acquiring section 19. Therefore, the non-case element acquiring section 20 is aimed at acquiring “ADJUNCT” other than the relative clauses. As shown in FIG. 25 (the same f-structure as FIG. 14), “joseiha (a woman followed by a particle) is acquired as a non-case element modifying “musumedesu (is a daughter)” (identifier “645”); “imoutode (is a sister)” is acquired as a non-case element modifying “suwatteriru (is sitting)” (identifier “1784”); and “watashino (my)” is acquired as a non-case element modifying “onnanoko (girl)” (identifier “54”) on the basis of the semantic analysis result candidates corresponding to FIG. 14. Such non-case element acquisition is carried out upon all the analysis result candidates retained by the analysis result retaining section 13.

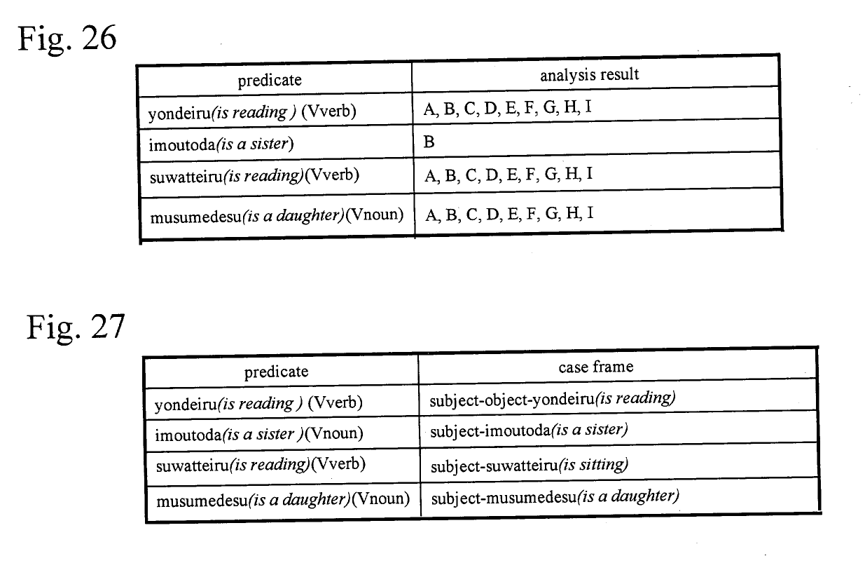

The predicate determining section 21 has a user interface as follows. That is, when a portion whose predicate is not constant (ambiguity of predicate) is found in a specific sentence with reference to all the predicates obtained from the predicate acquiring section 17, the information about the portion will be presented to a user for disambiguation. For example, on the assumption that nine analysis result candidates shown in FIGS. 5 to 13 (FIGS. 14 to 22) are referred to as A, B, C, D, E, F, G, H and I, respectively, the listed predicates are associated with the analysis result candidates including the predicates as shown in FIG. 26. From this table, it is understood that there occurs ambiguity that only the analysis result candidate B has “imoutoda (de) (“a sister” followed by auxiliary verb)” (corresponding to the node (Vnoun) having the identifier “2772” in FIG. 6 and the list having the identifier “2772” in FIG. 15) as a predicate while the other analysis result candidates do not have “imoutoda (de) (“a sister” followed by auxiliary verb)” as a predicate. The ambiguity is presented to the user in the following form. That is, a predicate (a predicate in canonical form) obtained by the predicate acquiring section 17 and a corresponding case element (and its phrasal modifier) obtained by the case element acquiring section 19 are presented together, and the user is asked whether a sentence makes sense or not. As a result, when a c-structure can be determined uniquely, the c-structure is delivered to the tagging section 26. When a c-structure cannot be determined, a set of candidates of c-structures left as possible correct analysis results are delivered to the case frame determining section 22.

The case frame determining section 22 has a user interfaceas follows. That is, when a portion whose case frame is not constant (ambiguity of case frame) is found in a specific sentence with reference to all the case frames of predicates obtained from the case frame acquiring section 18, the information about the portion will be presented to the user for disambiguation. As shown in FIG. 27, in the analysis result candidates A, B, C, D, E, F, G, H and I, there is no case that a plurality of case frames appear for one predicate. Thus, as for this example, there is no ambiguity of case frame.

When there is ambiguity of case frame, candidates of case frames are presented to the user. Alternatively, meanings of predicates (words mainly composing the predicates) corresponding to the case frames are presented to the user, respectively, with reference to the case frame dictionary retaining section 25 (as will be described later). Thus, the ambiguity is resolved. As a result, when a c-structure can be determined uniquely, the c-structure is delivered to the tagging section 26. When a c-structure cannot be determined, a set of candidates of c-structures left as possible correct analysis results are delivered to the case element determining section 23.

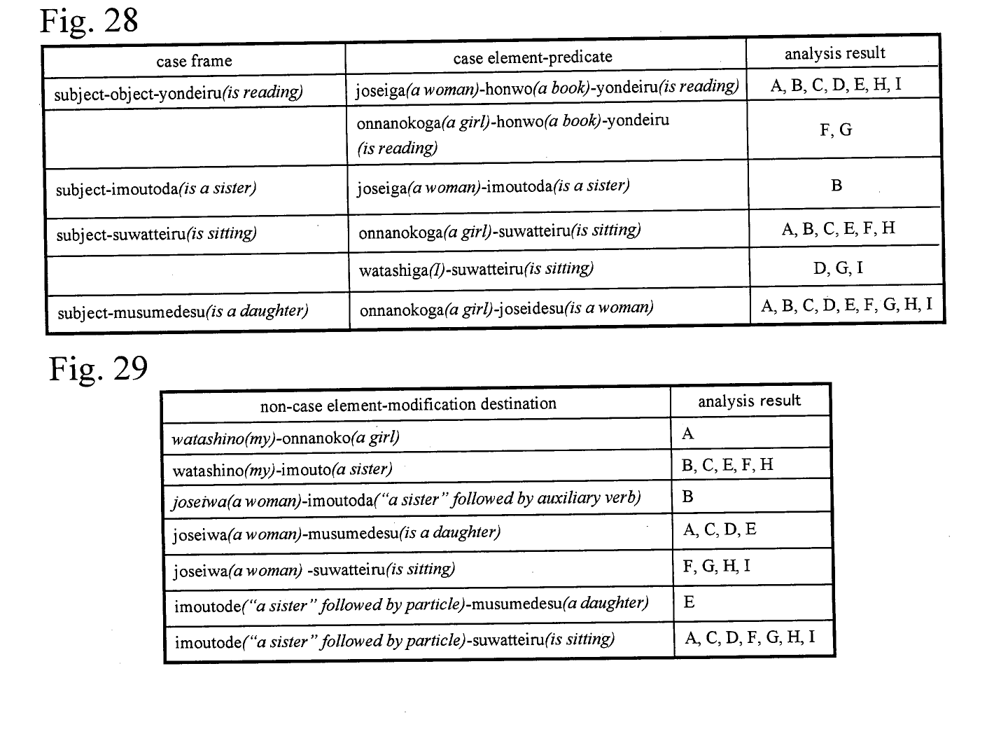

The case element determining section 23 has a user interface as follows. That is, when a portion whose case element is not constant (ambiguity of case element) is found in a case frame in a specific sentence with reference to all the predicates obtained from the predicate acquiring section 17 and all the case elements obtained from the case element acquiring section 19, the information about the portion will be presented to the user for disambiguation. As shown in FIG. 28, in the analysis result candidates A, B, C, D, E, F, G, H and I, there is ambiguity that two kinds of case elements (“josei (a woman) ” and “onnanoko (a girl)”, “onnanoko (a girl)” and “watashi (I)”) can correspond to the subjects of the predicates “yondeiru (is reading)” and “suwatteiru (is sitting)”, respectively.

When there is ambiguity of case element, candidates of case elements are presented to the user. Thus, the ambiguity is resolved. As a result, when a c-structure can be determined uniquely, the c-structure is delivered to the tagging section 26. When a c-structure cannot be determined, a set of candidates of c-structures left as possible correct analysis results are delivered to the non-case element determining section 24.

The non-case element determining section 24 has a user interface as follows. That is, when a portion whose non-case element has an inconstant modification destination (ambiguity of modification destination) is found in a specific sentence with reference to all the non-case elements obtained from the non-case element acquiring section 20 and the modification destinations of the non-case elements, the information about the portion will be presented to the user for disambiguation. In the analysis result candidates A, B, C, D, E, F, G, H and I, there is ambiguity of modification destination as shown in FIG. 29.

When there is ambiguity of modification destination of non-case element, candidates of modification relationships are presented to the user. Thus, the ambiguity is resolved. As a result, a c-structure can be determined uniquely. The obtained c-structure is delivered to the tagging section 26.

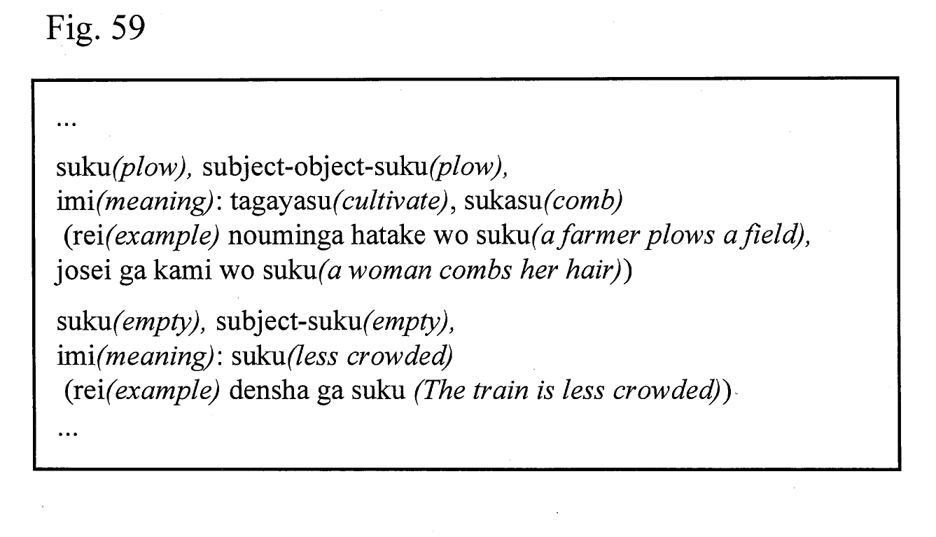

The case frame dictionary retaining section 25 retains a list of case frames required when the LFG analysis section 12 performs parsing/semantic analysis. That is, the case frame dictionary retaining section 25 lists possible case frames for each word dominating a case frame such as a verb and an adjective, and associates the possible case frames with meanings or example sentences of the word, respectively. FIG. 59 shows an example of case frame description corresponding to a verb “suku (plow or empty)”. The list of case frames is also used for the case frame determining section 22 to disambiguate the case frame.

The tagging section 26 receives the c-structure determined as a final analysis result by the predicate determining section 21, the case frame determining section 22, the case element determining section 23 or the non-case element determining section 24. Then, the tagging section 26 adds the obtained tree structure to the sentence retained in the analysis-target sentence retaining section 11 in the form of tags.

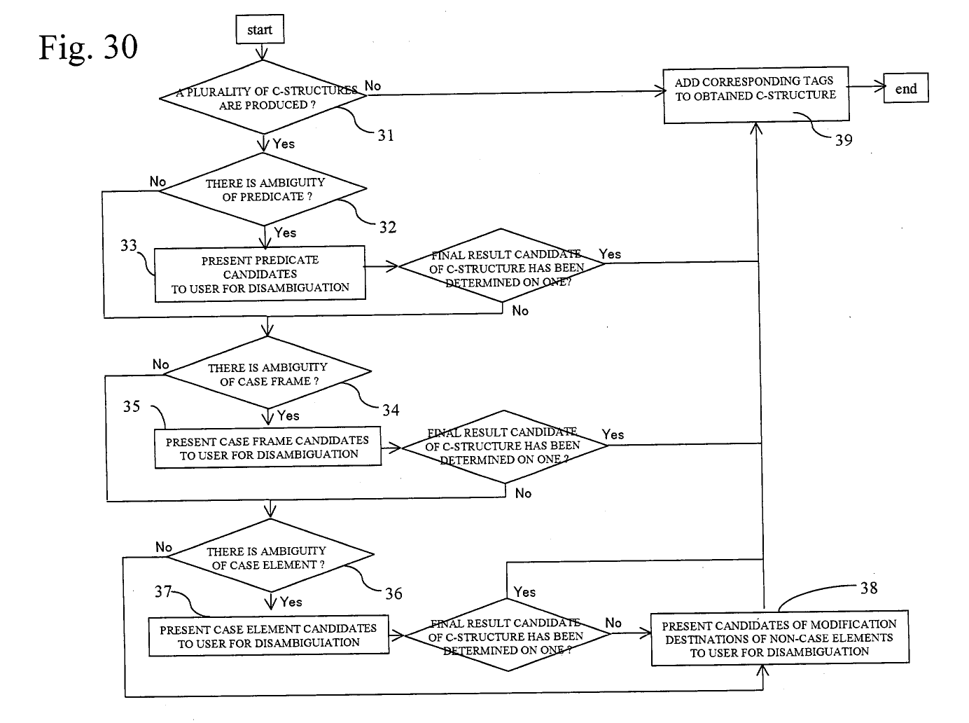

The flow of processing upon one sentence by the semantic analysis result determining section 16 will be described with reference to the flow chart of FIG. 30.

[Step 31]

The semantic analysis result determining section 16 receives c-structure candidates and f-structure candidates as analysis result candidates for an input sentence from the LFG analysis section 12. When number of c-structure candidates is one, the process proceeds to [Step 39]. When not one, the process proceeds to [Step 32].

[Step 32]

When there is ambiguity of predicate, the process proceeds to [Step 33]. When not so, the process proceeds to [Step 34]. (When all the analysis result candidates have one and the same predicate, the process proceeds to [Step 34]. When not so, the process proceeds to [Step 33].)

[Step 33]

Predicate candidates are presented to the user for disambiguation. When a c-structure is determined uniquely, the process proceeds to [Step 39]. When not so, the process proceeds to [Step 34].

[Step 34]

When there is ambiguity of case frame, the process proceeds to [Step 35]. When not so, the process proceeds to [Step 36].

[Step 35]

Case frame candidates or meanings indicating the case frame candidates are presented to the user so as to disambiguate. When a c-structure is determined uniquely, the process proceeds to [Step 39]. When not so, the process proceeds to [Step 36].

[Step 36]

When there is ambiguity of a case element, the process proceeds to [Step 37]. When not so, the process proceeds to [Step 38].

[Step 37]

Case element candidates are presented to the user for disambiguation. When a c-structure is determined uniquely, the process proceeds to [Step 39]. When not so, the process proceeds to [Step 38].

[Step 38]

Candidates of the modification destination of a non-case element are presented to the user for disambiguation. Then, the process proceeds to [Step 39].

[Step 39]

The determined c-structure is acquired, and syntactic tags corresponding to the c-structure are added to the input sentence.

### EXAMPLE 1

Description will be made below on the flow of processing when the input sentence is “hon wo yondeiru josei wa watashi no imouto de suwatteiru onnanoko ga musume desu.” (Japanese sentence)—meaning that “A woman who is reading a book is my sister and a gird who is sitting is a daughter.” Nine kinds of c-structures in FIGS. 5 to 13 are obtained from the input sentence as described previously. In addition, one-to-one correspondence between the c-structures and f-structures (FIGS. 14 to 22) is obtained. A plurality of f-structures are generally obtained for one c-structure. In that case, however, it is not necessary to make any change in the processing of the flow chart shown in FIG. 30.

As shown in FIG. 26, the nine analysis result candidates are classified into two groups. One group of analysis result candidates (A, C, D, E, F, G, H and I) indicates the three “yondeiru (is reading)”, “suwatteiru (is sitting)” and “musumedesu (is a daughter)” as predicates. The other group of an analysis result candidate (B) indicates the four “yondeiru (is reading)”, “imoutoda (is a sister)”, “suwatteiru (is sitting)” and “musumedesu (is a daughter)” as predicates. Therefore, in [Step 33], confirmation is made with the user as to whether “imoutoda (is a sister)” is a predicate or not, by use of a user interface as shown in FIG. 31. In this case, since “imoutoda (is a sister)” is a predicate, “sense” is chosen. Accordingly, a correct analysis result is determined uniquely on B (c-structure of FIG. 6), and tagging corresponding to FIG. 6 is carried out in [Step 39].

### EXAMPLE 2

Next, description will be made on the flow of processing when the input sentence is “hasan shinsei wo shinkokushiteiru hitomukashi mae ha manin no kankoukyaku de nigiwatte ita rizouto shisetsu ga koko desu” (Japanese sentence)—meaning “This is the resort facility which was once packed with tourists but is now filing a petition for bankruptcy.” This Japanese sentence has quite the same apparent structure as the Japanese sentence “hon wo yondeiru josei ha watashi no imouto de suwatteiru onnanoko ga musume desu.” (example 1)—meaning “A woman who is reading a book is my sister and a girl who is sitting is a daughter.”, merely with words of nouns and verbs and the tense being changed (Of course, the English translations of the Japanese sentences have different apparent structures from each other. This difference is caused by differences in linguistic features between Japanese and English. Here, “the same apparent structure” means that the orders of the part of speech are the same between the sentences.) Therefore, nine kinds of c-structures and f-structures having the same structures shown in FIGS. 5 to 13 and FIGS. 14 to 22, respectively, are obtained from the LFG analysis section 12. The nine analysis result candidates will be referred to as A, B, C, D, E, F, G, H and I in the same manner as in the example 1.

First, in [Step 33] in the same manner as in the example 1, by use of a user interface as shown in FIG. 32, confirmation is made with the user as to whether “kankoukyaku da (de) (is tourist)” is a predicate or not. In this case, since “kankoukyaku da (de) (is tourist)” is not a predicate, “no sense” is chosen. Thus, a correct analysis result is narrowed down to the eight candidates other than B.

In the same manner as the case frames shown in FIG. 27, also in this input sentence, there is no ambiguity of case frame. Therefore, [Step 34] is not executed.

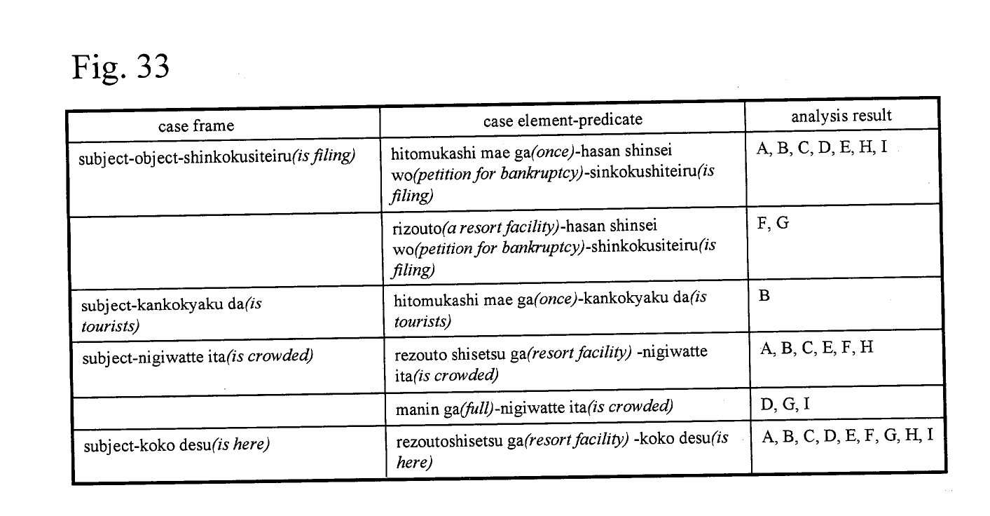

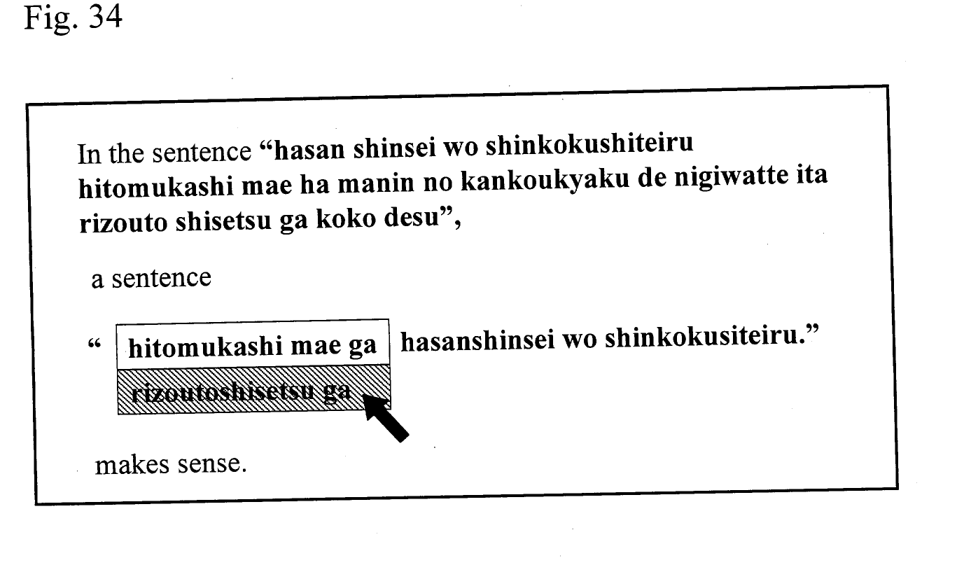

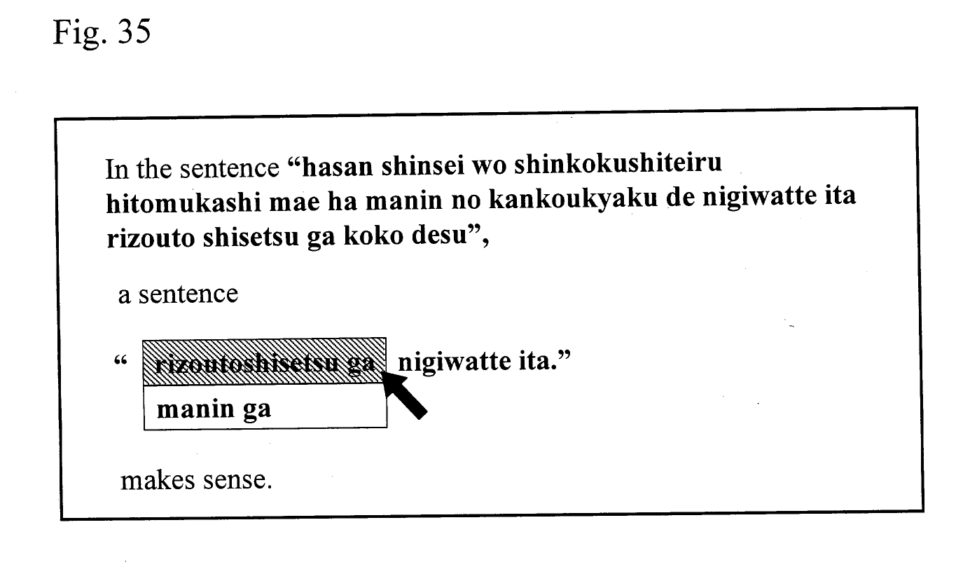

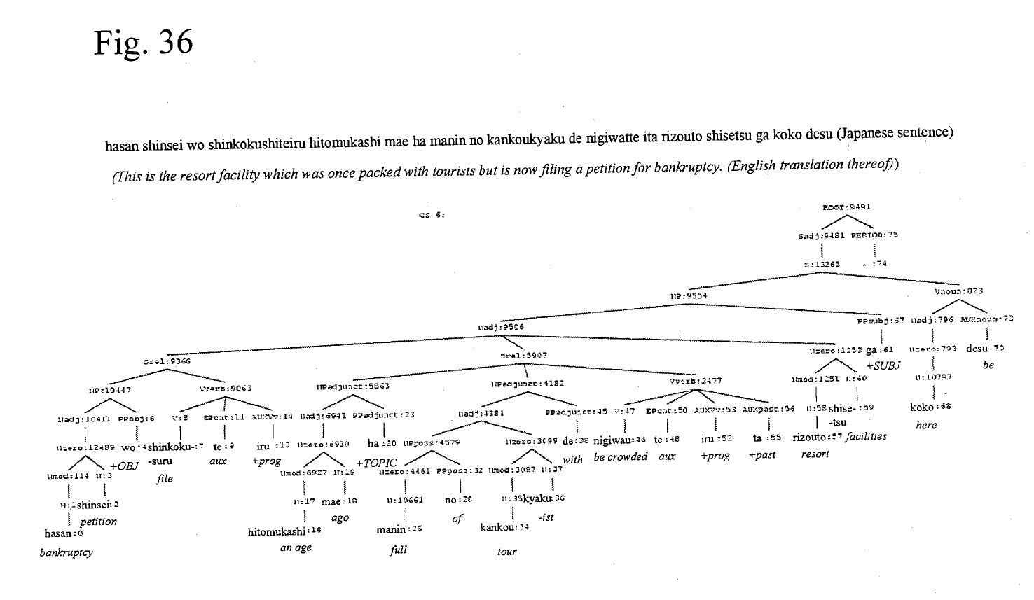

In the same manner as the case elements shown in FIG. 28, also in this input sentence, there is ambiguity of case element as shown in FIG. 33. That is, either “hitomukashi mae (an age ago)” or “rizouto shisetsu (resort facility)” can be a subject of “shinkokushiteiru (is filing)”. (The object of “shinkokushiteiru (filing)” is always “hasan shinsei (a petition for bankruptcy)”, with no ambiguity about it.) In addition, either “rizouto shisetsu (resort facility)” or “manin (full)” can be a subject of “nigiwatteita (crowded)”. Therefore, a user interface as shown in FIGS. 34 and 35 is used in [Step 37] for disambiguating the case elements. In FIG. 34, “rizouto shisetsu ga (resort facility followed by a particle)” is chosen. Thus, a correct analysis result is narrowed down to the candidates “F and G” with reference to FIG. 33. Further, also in FIG. 35, “rizouto shisetsu ga (resort facility followed by a particle)” is chosen. Thus, the correct analysis result is determined uniquely on F (c-structure of FIG. 36). Then, tagging corresponding to FIG. 36 is carried out in [Step 39].

### EXAMPLE 3

Next, description will be made on the flow of processing when the input sentence is “danbou setsubi wo motanai itumo ha kanojo no hitori de sugoshite iru heya ga shinkyo desu.” (Japanese sentence)—meaning “The room without heating equipment in which she always spends times alone is the place where she now lives with her husband.” This Japanese sentence also has quite the same apparent structure as the Japanese sentence “hon wo yondeiru josei ha watashi no imouto de suwatteiru onnanoko ga musume desu.” (example 1)—meaning “A woman who is reading a book is my sister and a girl who is sitting is a daughter.”, merely with words of nouns and verbs and the tense being changed (Of course, the English translations of the Japanese sentences have different apparent structures from each other. This difference occurs due to differences in linguistic features between Japanese and English). Therefore, nine kinds of c-structures and f-structures having the same structures shown in FIGS. 5 to 13 and FIGS. 14 to 22, respectively, are obtained from the LFG analysis section 12. The nine analysis result candidates will be referred to as A, B, C, D, E, F, G, H and I in the same manner as in the example 1.

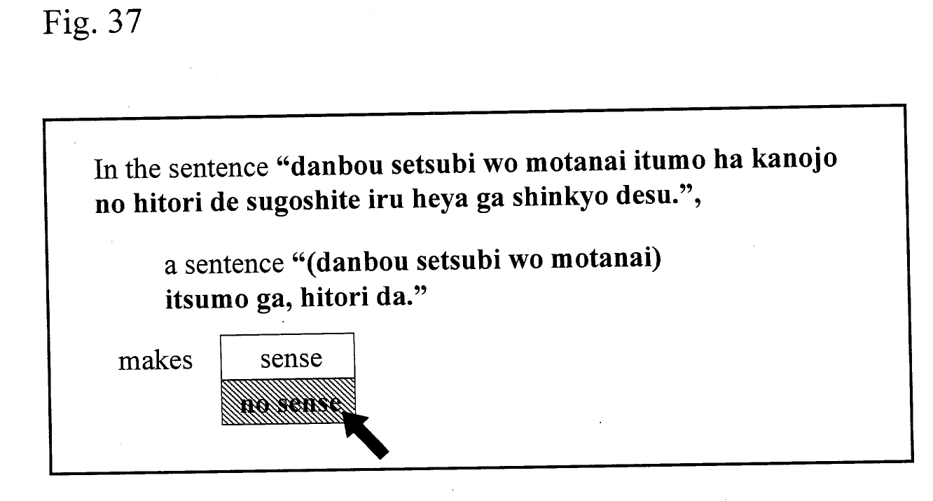

First, in [Step 33] in the same manner as in the example 1, by use of a user interface as shown in FIG. 37, confirmation is made with the user as to whether “hitori da (de) (alone)” is a predicate or not. In this case, since “hitori da (de) (alone)” is not a predicate, “no sense” is chosen. Thus, a correct analysis result is narrowed down to the eight candidates other than B.

In the same manner as the case frame shown in FIG. 27, there is no ambiguity of case frame in this input sentence. Therefore, [Step 34] is not executed.

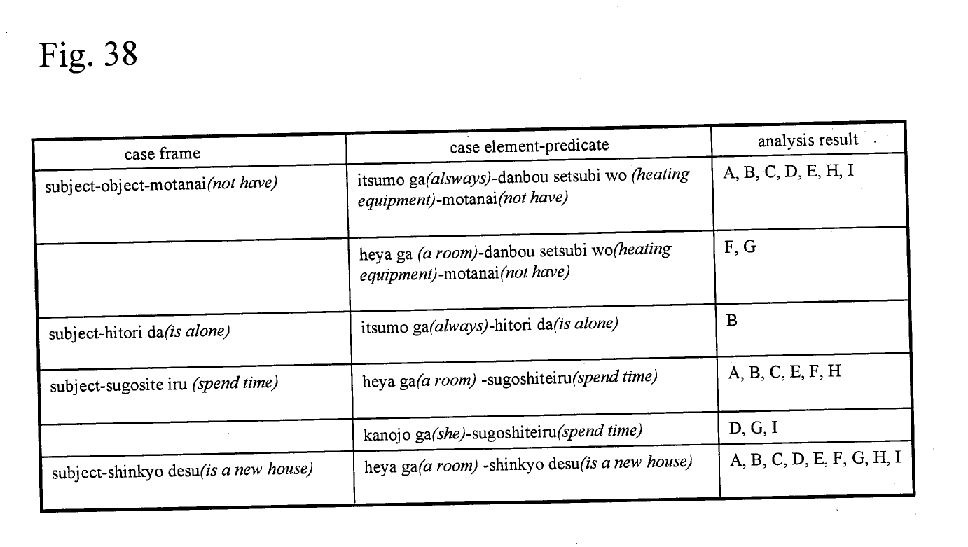

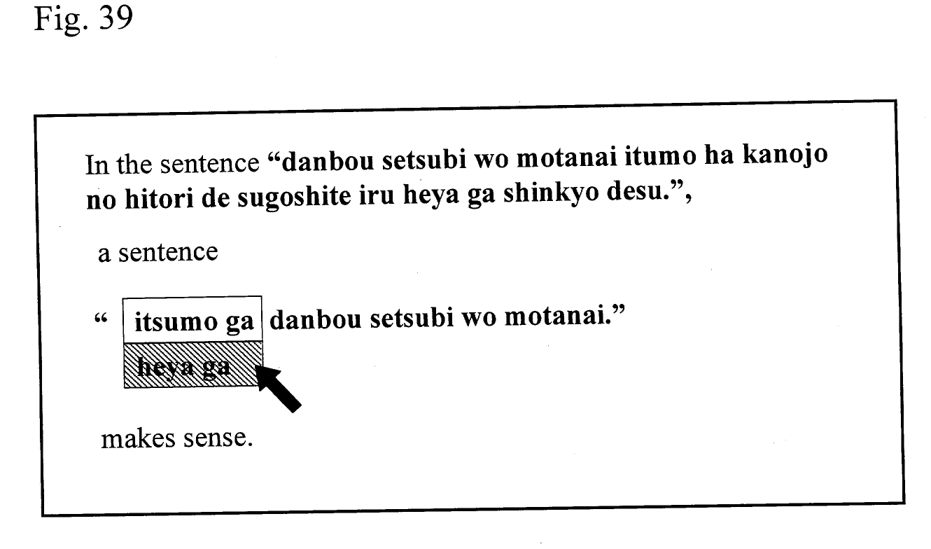

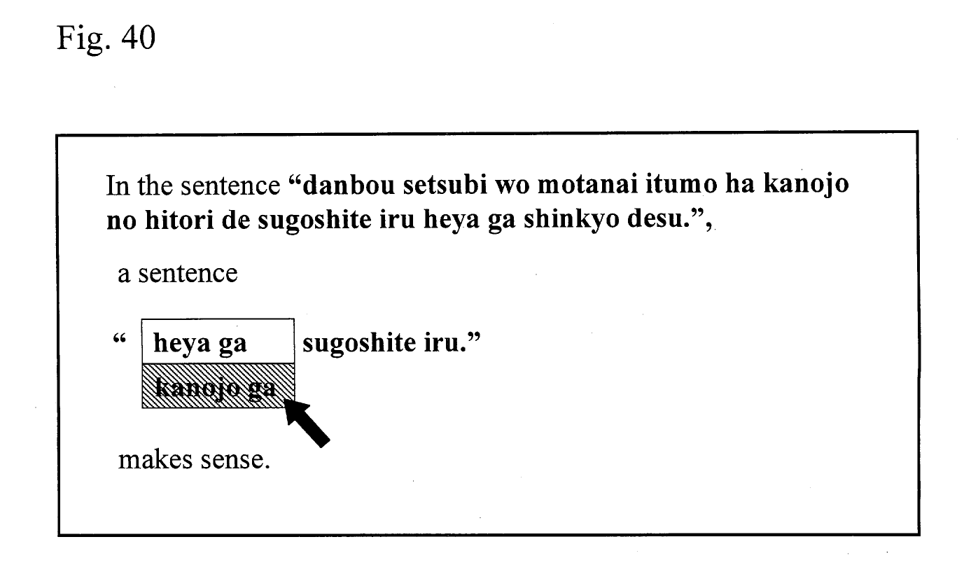

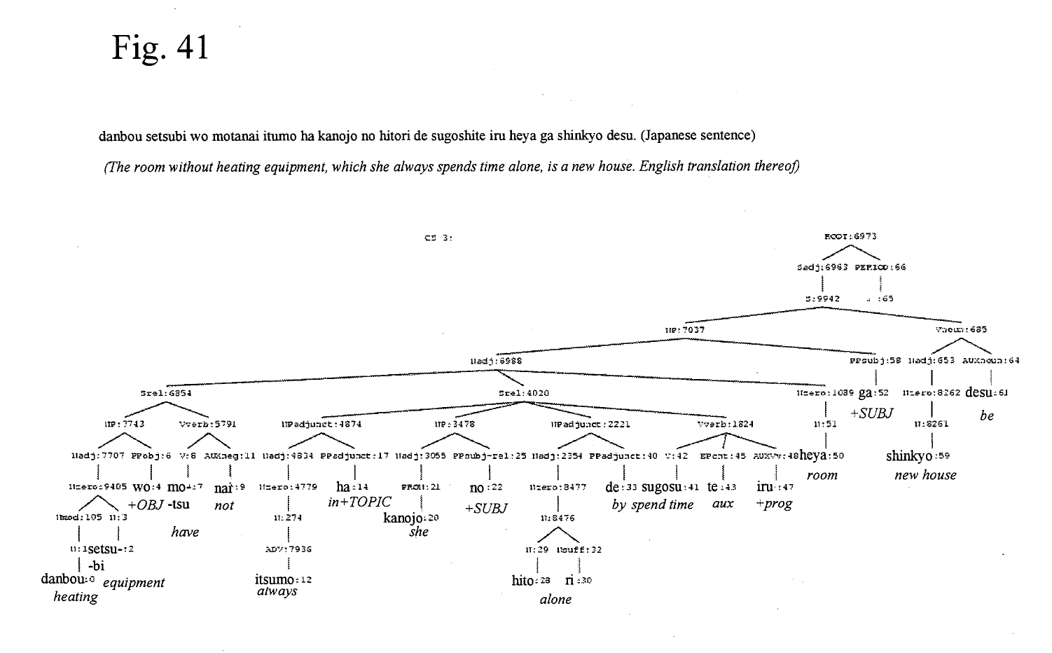

In the same manner as the case elements shown in FIG. 27, also in this input sentence, there is ambiguity of case element as shown in FIG. 38. That is, either “itsumo (always)” or “heya (room)” can be a subject of “motanai (not have)”. (The object of “motanai (not have)” is always “danbou setsubi (heating equipment”, with no ambiguity about it.) In addition, either “heya (room)” or “kanojo (she)” can be a subject of “sugoshiteiru (spend time)”. Therefore, a user interface as shown in FIGS. 39 and 40 is used in [Step 37] so as to disambiguating the case elements. In FIG. 39, “heya ga (room)” is chosen. Thus, a correct analysis result is narrowed down to the candidates “F and G” with reference to FIG. 38. Further, in FIG. 40, “kanojo ga (she)” is chosen. Thus, the correct analysis result is determined uniquely on G (c-structure of FIG. 41). Then, tagging corresponding to FIG. 41 is carried out in [Step 39].

### EXAMPLE 4

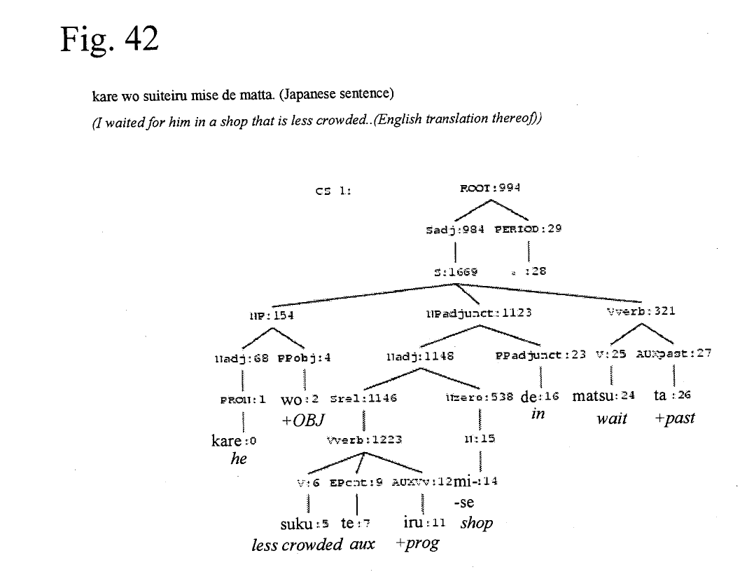

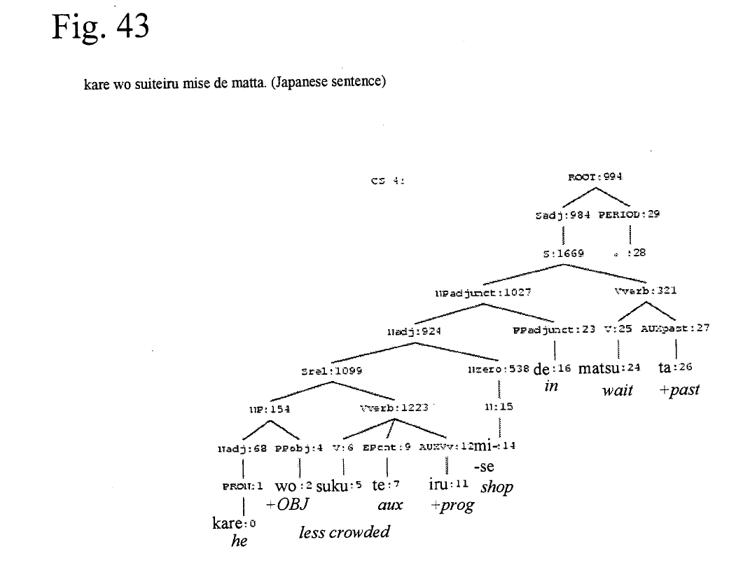

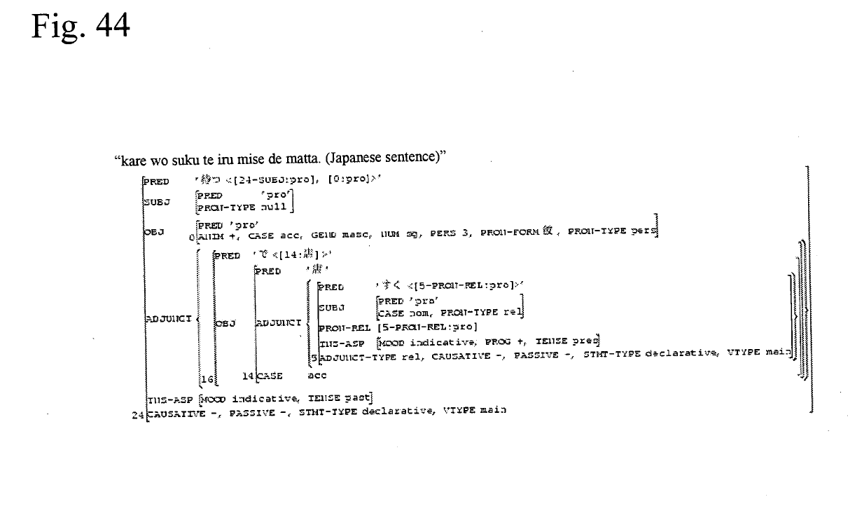

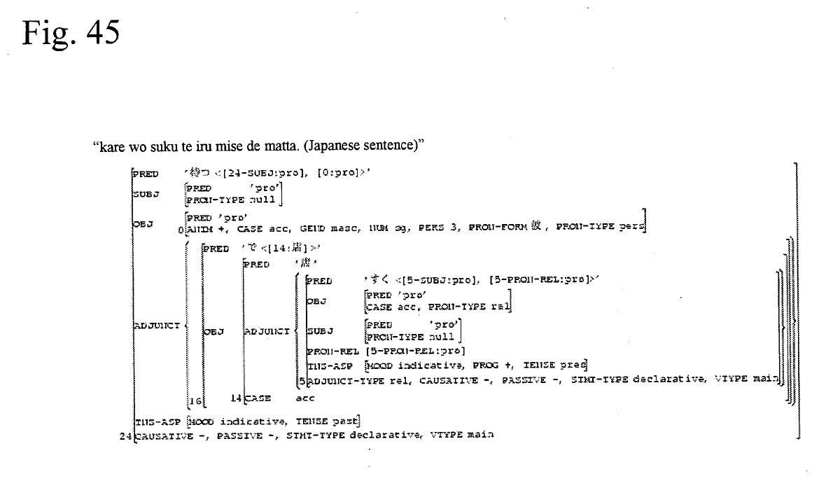

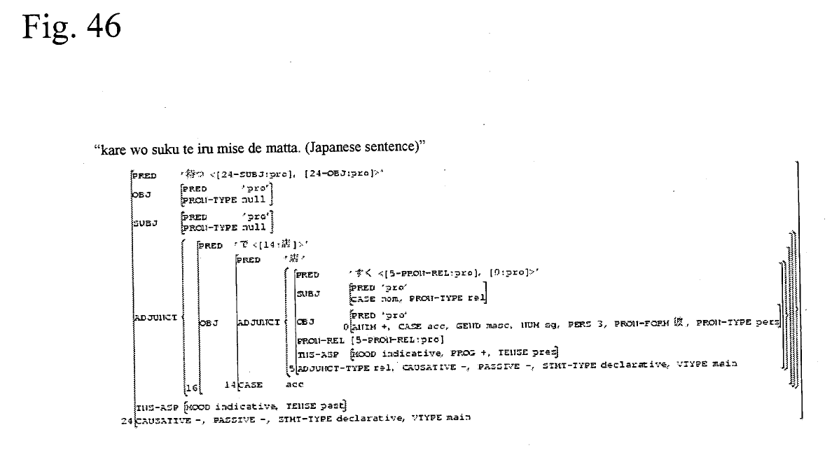

The flow of processing when the input sentence is “kare wo suiteiru mise de matta.” (Japanese sentence)—meaning “I waited for him in a shop that was less crowded.”—will be described as follows. In this case, c-structures shown in FIGS. 42 and 43 are obtained from the LFG analysis section 12. In addition, FIGS. 44 and 45 are obtained as f-structures corresponding to the c-structure of FIG. 42, while FIG. 46 is obtained as an f-structure corresponding to the c-structure of FIG. 43. The analysis result candidates of FIGS. 44 to 46 will be referred to as A, B and C. In this case, the predicates “suiteiru (plow or less crowded)” and “matta (waited)” are common among all the analysis result candidates (A, B and C), and there is no ambiguity of predicate. Therefore, [Step 33] is not executed. It is noted that in Japanese, verb “suiteiru” represents two different meanings, that is, “suiteiru” is homophone. One meaning corresponds to “plow” or “comb” in English. The other meaning corresponds to “not crowd” in English.

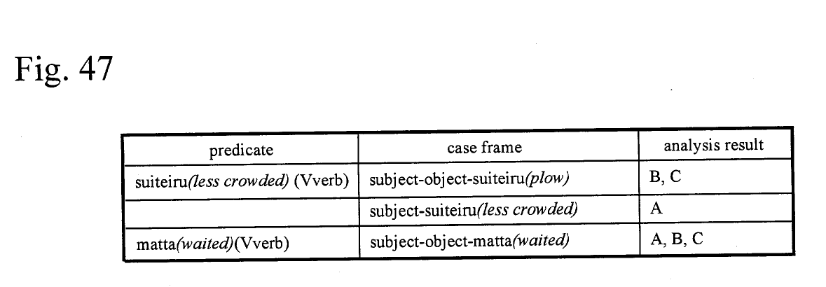

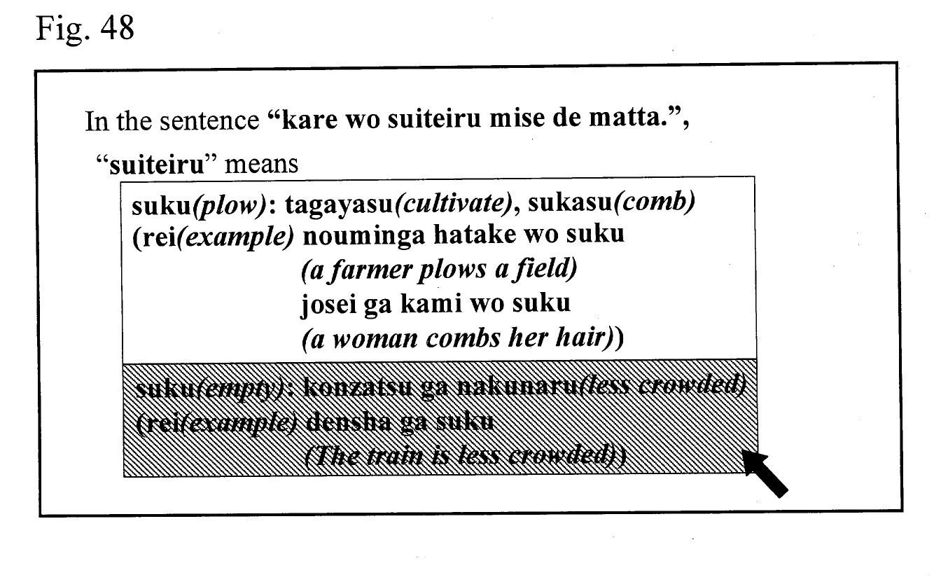

For the input sentence, there is ambiguity of case frame as shown in FIG. 47. That is, either the following cases makes sense. One case is that “suiteiru (less crowded)” has a case frame (intransitive verb) accompanying only a subject. The other case is that “suiteiru (plow)” has a case frame (transitive verb) accompanying both a subject and an object. Therefore, in [Step 35], a user interface as shown in FIG. 48 is used to disambiguate the case frame with reference to FIG. 59. In FIG. 48, “suiteiru (less crowded)”, which is an intransitive verb, is chosen. Thus, a correct analysis result is determined uniquely on A (c-structure of FIG. 42). Then, tagging corresponding to FIG. 42 is carried out in [Step 39].

### EXAMPLE 5

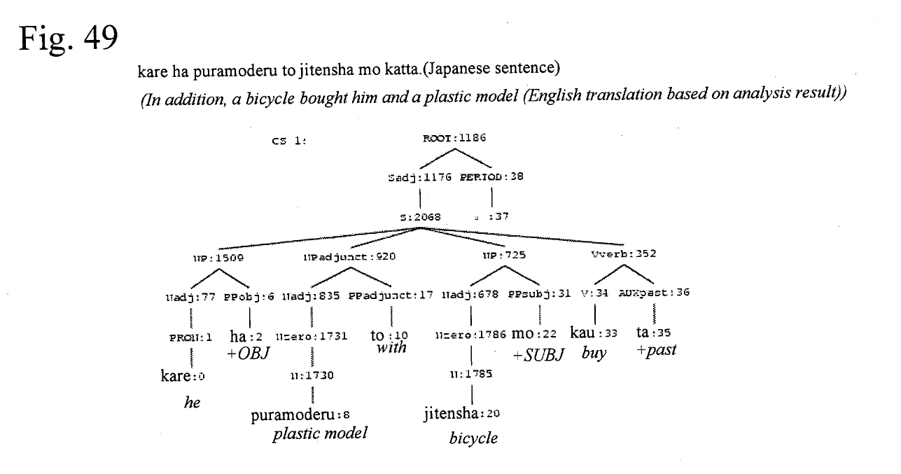

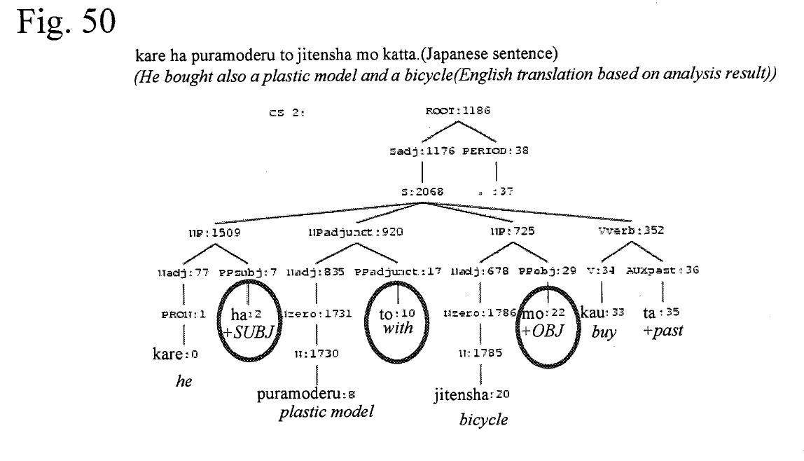

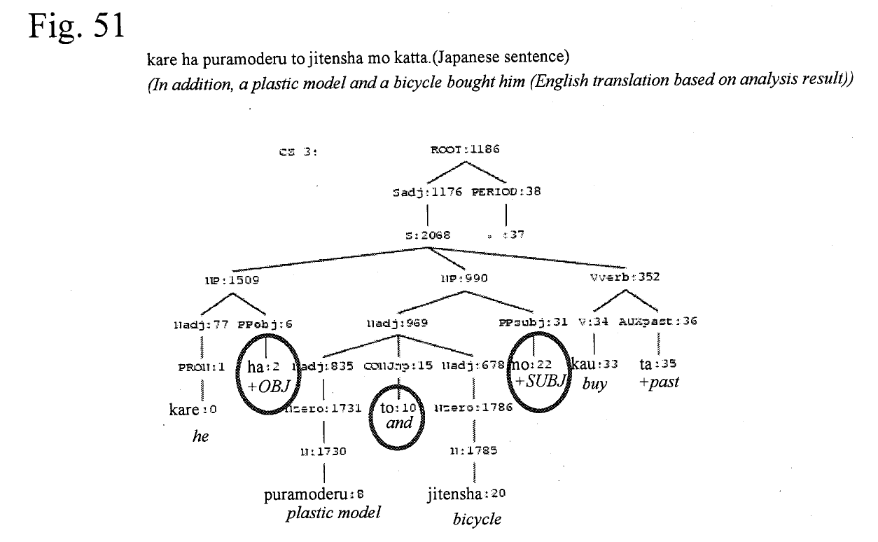

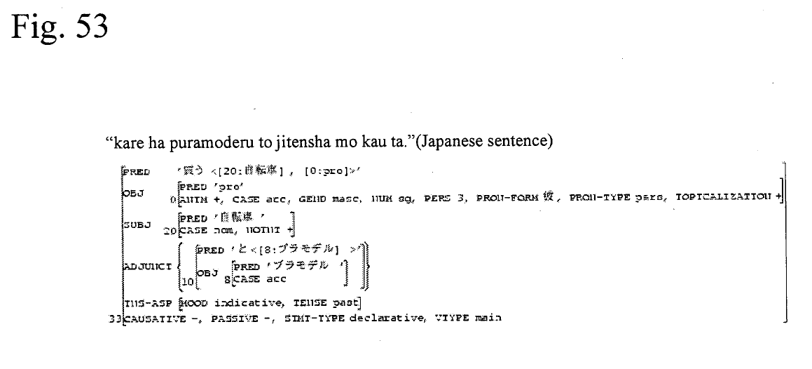

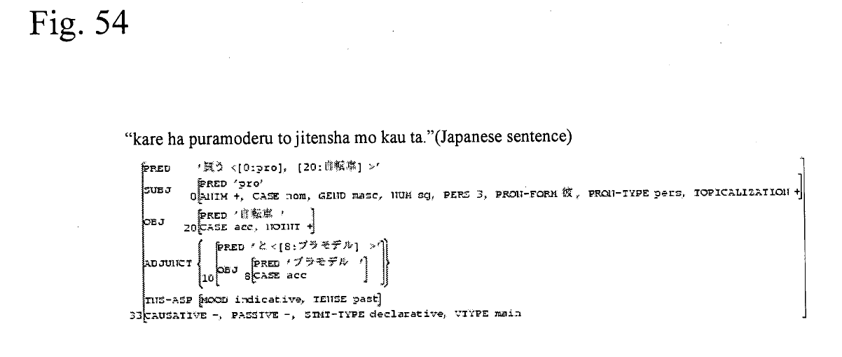

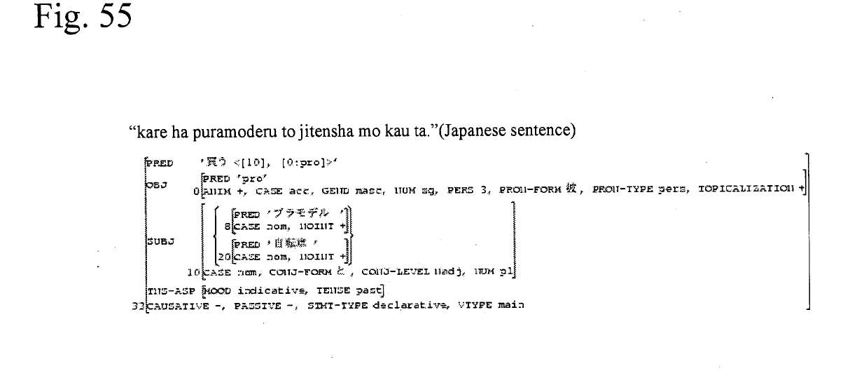

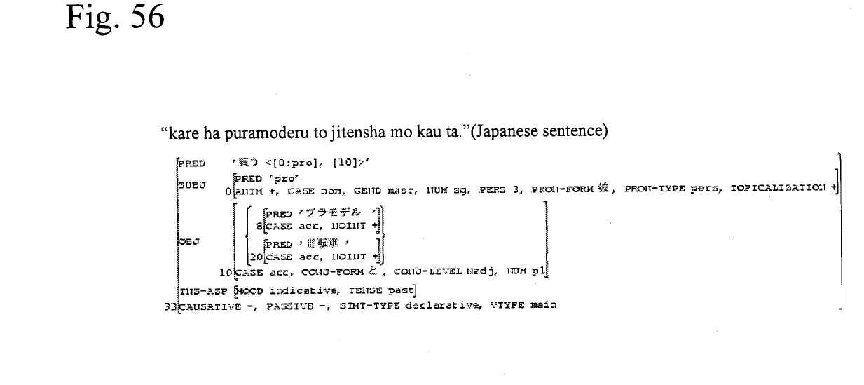

The flow of processing when the input sentence is “kare ha puramoderu to jitensha mo katta.” (Japanese sentence)—meaning “He bought also a plastic model and a bicycle.”—will be described as follows. In this case, both “ha” and “mo” in the sentence are dependent particles that can express a subject (+SUBJ) or an object (+OBJ). Therefore, four c-structures shown in FIGS. 49 to 52 are obtained from the LFG analysis section 12. In addition, FIGS. 53 to 56 are obtained as f-structures corresponding to the c-structures, respectively. The analysis result candidates will be referred to as A, B, C and D. In this case, the predicate “katta (bought)” is common among all the analysis result candidates (A, B, C and D), and there is no ambiguity of predicate. Therefore, [Step 33] is not executed. In addition, the case frame “SUBJ-OBJ-katta (bought)” is fixed among all the analysis result candidates, and there is no ambiguity of case frame. Therefore, [Step 35] is not executed, either.

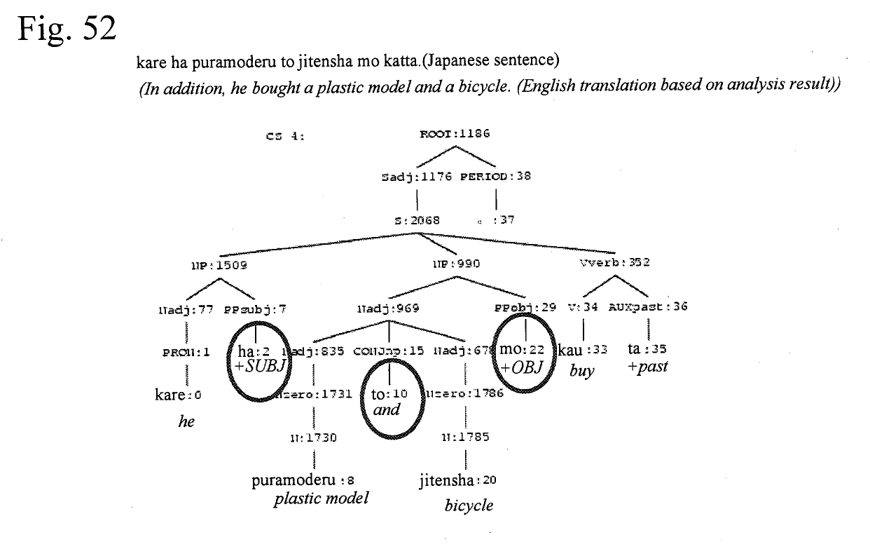

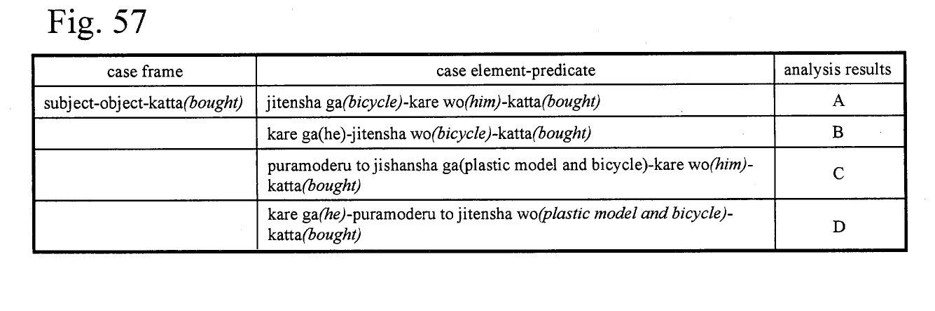

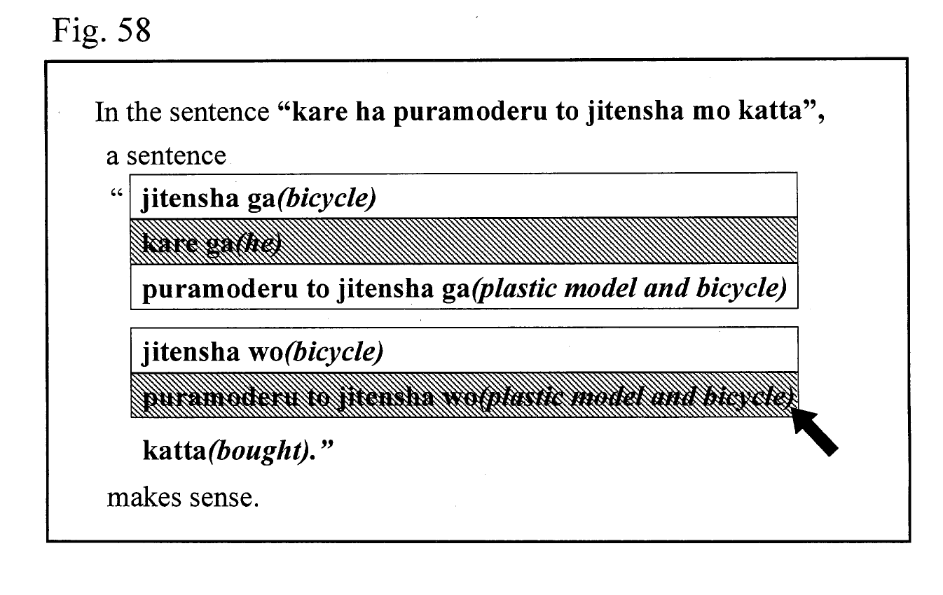

For the input sentence, there is ambiguity of case element as shown in FIG. 57. Therefore, in [Step 37], a user interface as shown in FIG. 58 is used to disambiguate the case element. FIG. 58 shows that “kare ga (he)” and “puramoderu to jitensha wo (a plastic model and a bicycle)” has been chosen. Thus, a correct analysis result is determined uniquely on D (c-structure of FIG. 52). Then, tagging corresponding to FIG. 52 is carried out in [Step 39]. Incidentally, with reference to FIG. 57, the object is narrowed down to either “jitensha wo (a bicycle)” or “puramoderu to jitensha wo (a plastic model and a bicycle)” when “kare ga (he)” has been chosen.

### EXAMPLE 6

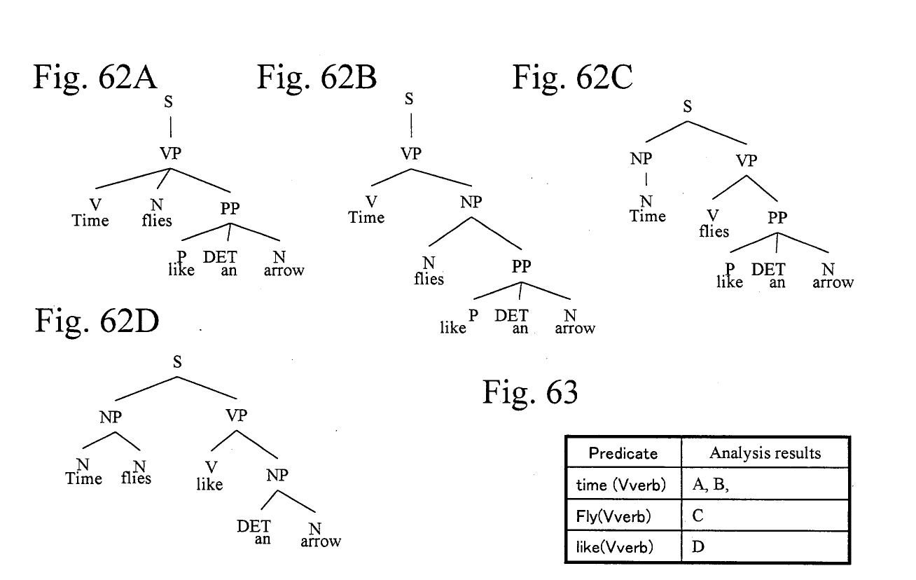

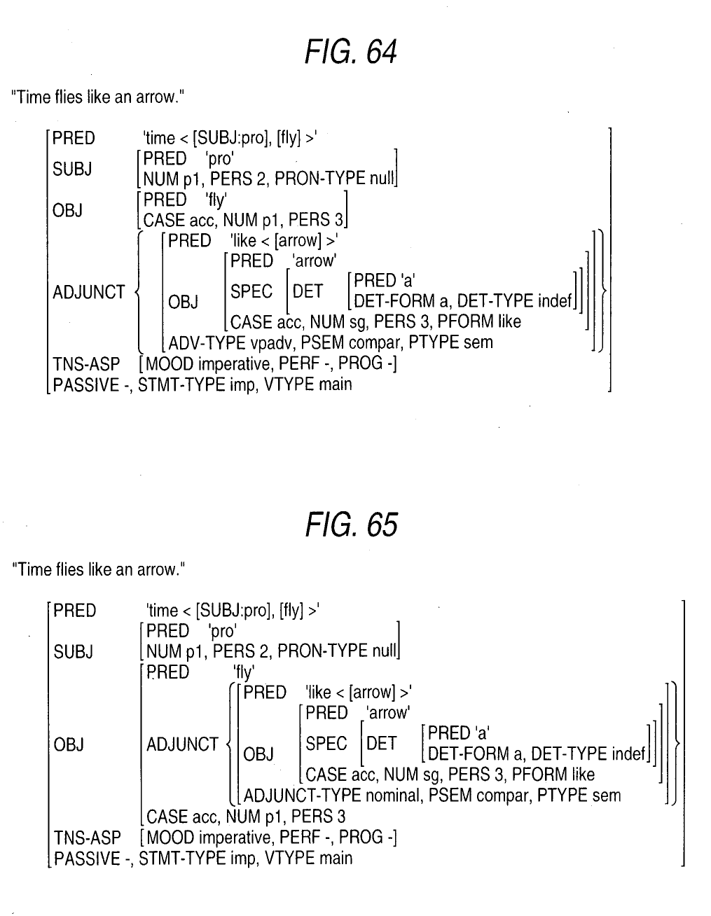

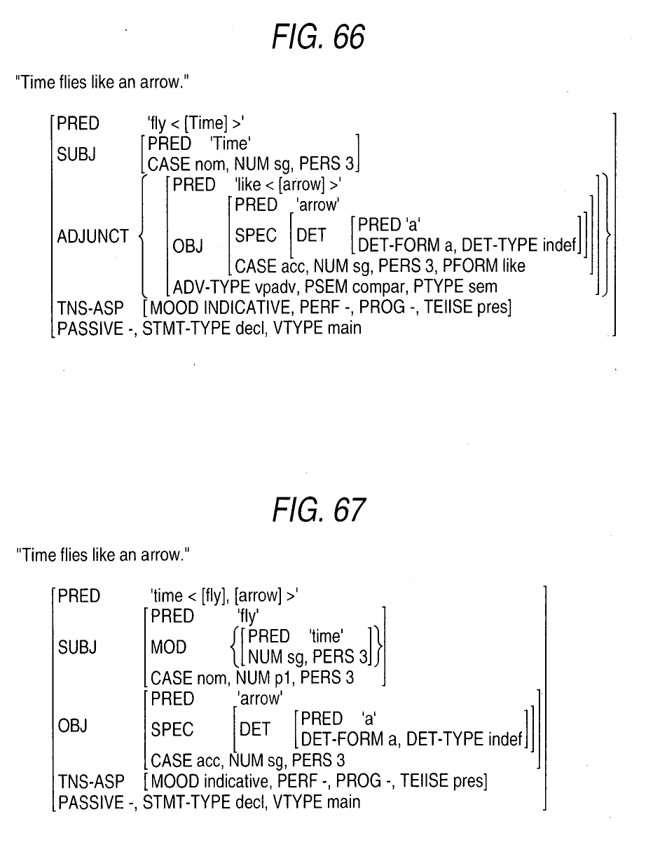

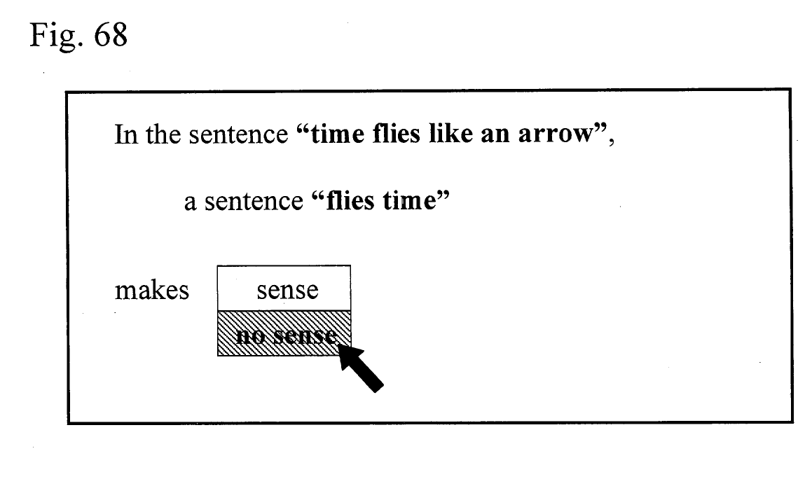

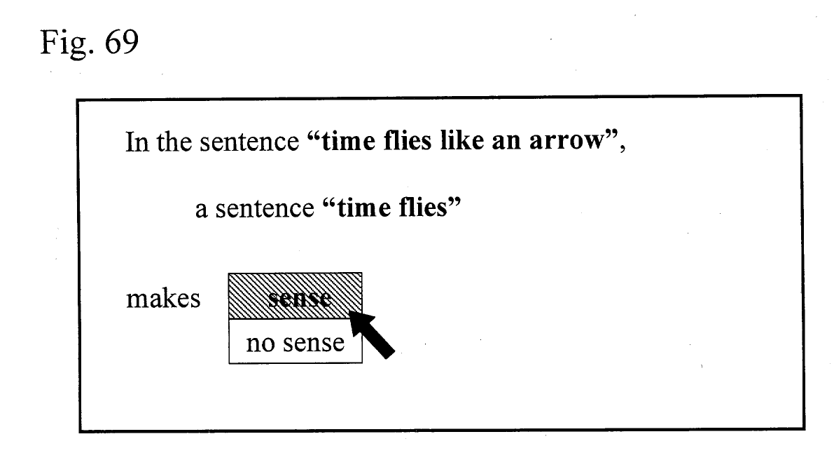

The flow of processing when the input sentence is “Time flies like an allow”. In the example 6, four c-structures shown in FIGS. 62(A) to 62(D) are obtained from the LFG analysis section 12. In addition, FIGS. 64 to 67 are obtained as f-structures corresponding to the c-structures, respectively. The analysis result candidates will be referred to as A, B, C and D. As shown in FIG. 63, the four analysis result candidates are classified into three groups. A first group consisting of analysis result candidates A and B indicates “time” as a predicate. A second group consisting of analysis candidate C indicates “fly” as a predicate. A third group consisting of analysis candidate D indicates “like” as a predicate. Therefore, in [Step 33], confirmation is made with the user as to whether “time” is a predicate or not, by use of a user interface as shown in FIG. 68. In this case, since “time” is a predicate, “no sense” is chosen. Sequentially, another confirmation is made with the user as to whether “fly” is a predicate or not, by use of a user interface as shown in FIG. 69. Since “fly” is a predicate, “sense” is chosen. Accordingly, a correct analysis result is determined uniquely on C (c-structure of FIG. 62C), and tagging corresponding to FIG. 66 is carried out in [Step 39].

In this embodiment, as shown in FIG. 30, there is adopted a configuration to disambiguate the order of predicate, case frame, case element, and non-case element. This is based on the policy of the LFG theory attaching importance to a case frame (grammatical role) around a predicate. However,, a similar effect can be obtained even if disambiguation is performed in a different order. For example, when a probabilistic parsing method is used to add a probability to each parsing result, there may be adopted a system to present a user by priority with a semantic analysis result corresponding to a parsing result having high reliability so as to resolve ambiguity.

In this embodiment, tags are added directly to a sentence as a target of analysis. However, it is apparent that the effect of the invention is unchanged in such a configuration that syntactic information tags are stored in another file together with pointers to the target sentence.

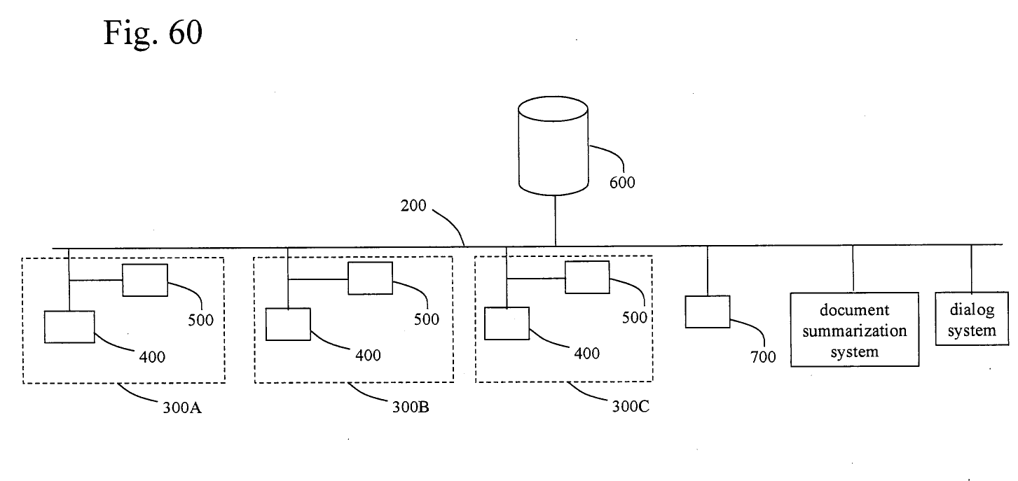

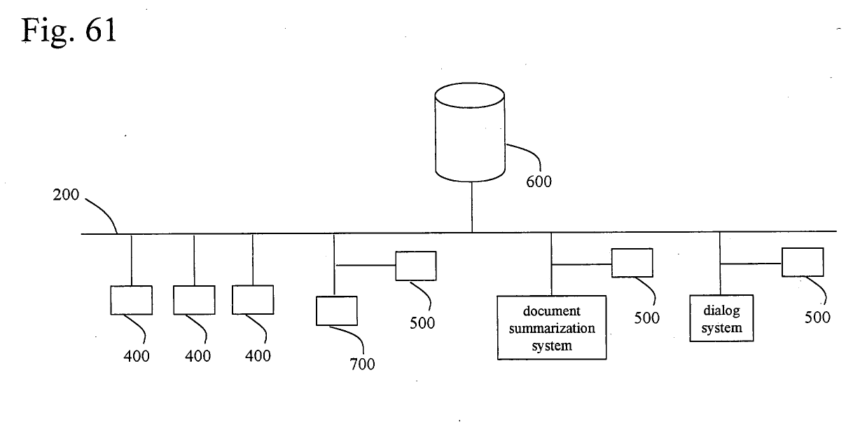

The syntactic information tagging support system shown in this embodiment can be implemented by software on a computer. The language processing thereof can be carried out in a distributed environment. For example, the following configuration can be considered. That is, a large number of host computers 300A, 300B, 300C, 300D, 300E and 300F are placed on a network 200 as shown in FIG. 60. Text made up by a word processor (or a voice recognition system) 400 is tagged by a tagging support system 500, and stored in a database 600 through the network 200. After that, the tagged text is used as an input to a machine translation system or the like 700 in accordance with necessity. The following use can be also considered as shown in FIG. 61. That is, text, which has not been tagged, is acquired from the database 600. The text is tagged by the tagging support system 500 as processing prior to the machine translation system 700 so as to improve the accuracy of translation.

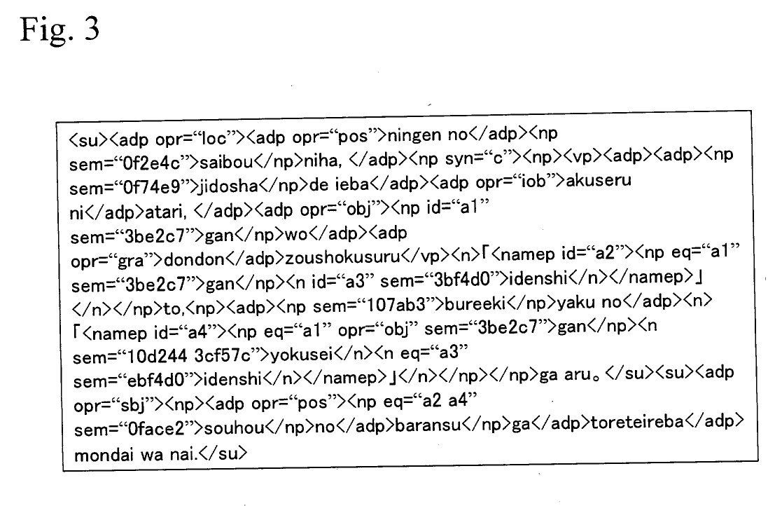

As described above, according to the invention, semantic analysis result candidates are presented to a user of the system so as to be subject to correction by the user. Thus, a correct semantic analysis result is acquired. A parsing result is determined on the basis of the obtained semantic analysis result. In such a manner, it is possible to provide a syntactic information tagging support system, which can tag sentences with correct syntactic information tags. Accordingly, it is not necessary to perform manual tagging, as shown in FIG. 3, which is difficult even for those skilled in linguistics or to edit a syntax tree manually as shown in FIG. 5 or the like. Instead, similar tagging can be achieved merely by an easy and visceral work as shown in FIG. 31, 32, 34, 35, 37, 39, 40, 48 or 58. That is, even those who are not familiar with linguistics can perform correct syntactic information tagging at much lower cost than in the related art. As a result, for example, the Japanese sentence “hon wo yondeiru josei ha watashi no imouto de suwatteiru onnanoko ga musume desu.” is tagged with correct syntactic information so that a correct translation result “The woman who is reading a book is my younger sister and a sitting girl is a daughter” can be obtained as a result of Japanese-to-English machine translation. In contrast, when the sentence is not tagged, a correct parsing result cannot be obtained in existing machine translation system. Thus, an erroneous translation, “The girl on whom the woman who is reading a book is sitting by my younger sister is a daughter” may be output.

What is claimed is:

1. A syntactic information tagging support method comprising:
retaining a target sentence for parsing;
performing parsing processing on the retained sentence to output parsing result candidates;
performing semantic analysis processing on the retained sentence to output semantic analysis result candidates;
retaining analysis result information including the parsing result candidates, the semantic analysis result candidates, and correspondence relations between the parsing result candidates and the semantic analysis result candidates;
determining a correct semantic analysis result by use of user interface for presenting the semantic analysis result candidates to a user so as to allow the user to select the correct semantic analysis result;
determining a parsing result based on the determined semantic analysis result and the retained analysis result information; and
performing tagging with tags indicating syntactic information upon the retained sentence based on the determined parsing result.

2. A syntactic information tagging support method comprising:
retaining a target sentence for parsing;
performing parsing processing on the retained sentence to output parsing result candidates;
performing semantic analysis processing on the retained sentence to output semantic analysis result candidates;
retaining analysis result information including the parsing result candidates, the semantic analysis result candidates, and correspondence relations between the parsing result candidates and the semantic analysis result candidates;
determining a correct semantic analysis result by use of user interface for presenting at least one optional item of the semantic analysis result, which is necessary to determine an analysis result, to a user based on the parsing result candidates and the semantic analysis result candidates so as to allow the user to select the correct semantic analysis result;
determining a correct parsing result candidates based on the determined semantic analysis result and the retained analysis result information; and
performing tagging with tags indicating syntactic information upon the retained sentence based on the determined parsing result.

3. The method according to claim 2,
wherein the optional item is a plurality of optional items; and
wherein in the correct semantic analysis result determining step, the user interface presents to the user the plurality of options by a predetermined order of priority.

4. The method according to claim 3, further comprising:
determining the predetermined order of priority based on the parsing result candidates and the semantic analysis result cadidates.

5. The method according to claim 4,
wherein in the priority order determining step, the order of priority is determined in an order of ambiguity of predicate, ambiguity of case frame, ambiguity of case element, and ambiguity of modification destination of non-case element.

6. The method according to claim 4,
wherein in the parsing processing performing step, a probability-including syntax tree is output; and
wherein in the priority order determining step, the order of priority for the optional items is determined based on reliability of the syntax tree.

7. The method according to claim 1,
wherein in the semantic analysis processing performing step, case information based on classification by grammatical roles is output.

8. The method according to claim 2,
wherein in the semantic analysis processing performing step, case information based on classification by grammatical roles is output.

9. The method according to claim 1,
wherein in the semantic analysis processing performing step, case information based on classification by semantic roles is output.

10. The method according to claim 2,
wherein in the semantic analysis processing performing step, case information based on classification by semantic roles is output.

11. A syntactic information tagging support system comprising:
an analysis target sentence retaining section for retaining a target sentence for parsing;
a parsing section for performing parsing processing on the sentence retained by the analysis target sentence retaining section to output parsing result candidates;
a semantic analysis section for performing semantic analysis processing on the sentence retained by the analysis target sentence retaining section to output semantic analysis result candidates;
an analysis result retaining section for retaining analysis result information including the parsing result candidates, the semantic analysis result candidates, and correspondence relations between the parsing result candidates and the semantic analysis result candidates;
a semantic analysis result determination section for determining a correct semantic analysis result by use of user interface for presenting the semantic analysis result candidates to a user so as to allow the user to select the correct semantic analysis result;
a parsing result determination section for determining a parsing result based on the determined semantic analysis result and the analysis result information retained by the analysis result retaining section; and
a tagging section for performing tagging with tags indicating syntactic information upon the sentence retained by the analysis target sentence retaining section based on the determined parsing result.

12. A medium in which a program is recorded, the program causing a computer to conduct a syntactic information tagging support comprising:
retaining a target sentence for parsing;
performing parsing processing on the retained sentence to output parsing result candidates;
performing semantic analysis processing on the retained sentence to output semantic analysis result candidates;
retaining analysis result information including the parsing result candidates, the semantic analysis result candidates, and correspondence relations between the parsing result candidates and the semantic analysis result candidates;
determining a correct semantic analysis result by use of user interface for presenting the semantic analysis result candidates to a user so as to allow the user to select the correct semantic analysis result;
determining a parsing result based on the determined semantic analysis result and the analysis result information retained; and
performing tagging with tags indicating syntactic information upon the retained sentence based on the determined parsing result.

13. A sentence analysis method comprising:
performing parsing processing on a target sentence for parsing to output parsing result candidates;
performing semantic analysis processing on the sentence to output semantic analysis result candidates;
retaining analysis result information including the parsing result candidates, the semantic analysis result candidates, and correspondence relations between the parsing result candidates and the semantic analysis result candidates;
determining a correct semantic analysis result by use of user interface for presenting the semantic analysis result candidates to a user so as to allow the user to select the correct semantic analysis result; and
determining a parsing result based on the determined semantic analysis result and the analysis result information retained.

14. A medium in which a program is recorded, the program causing a computer to conduct a sentence analysis comprising:
performing parsing processing on the sentence to output parsing result candidates;
performing semantic analysis processing on the sentence to output semantic analysis result candidates;
retaining analysis result information including the parsing result candidates, the semantic analysis result candidates, and correspondence relations between the parsing result candidates and the semantic analysis result candidates;
determining a correct semantic analysis result by use of user interface for presenting the semantic analysis result candidates to a user so as to allow the user to select the correct semantic analysis result; and
determining a parsing result based on the determined semantic analysis result and the analysis result information retained.

15. A syntactic-information-tagged sentence making method comprising:
retaining a target sentence for parsing;
performing parsing processing on the retained sentence to output parsing result candidates;
performing semantic analysis processing on the retained sentence to output semantic analysis result candidates;
retaining analysis result information including the parsing result candidates, the semantic analysis result candidates, and correspondence relations between the parsing result candidates and the semantic analysis result candidates;
determining a correct semantic analysis result by use of user interface for presenting the semantic analysis result candidates to a user so as to allow the user to select the correct semantic analysis result;
determining a parsing result based on the determined semantic analysis result and the analysis result information retained;
performing tagging with tags indicating syntactic information upon the retained sentence based on the determined parsing result; and
outputting the sentence, which the tags indicating the syntactic information is tagged with.

16. A medium in which a program is recorded, the program causing a computer to conduct making a syntactic-information-tagged sentence comprising:
retaining a target sentence for parsing;
performing parsing processing on the retained sentence to output parsing result candidates;
performing semantic analysis processing on the retained sentence to output semantic analysis result candidates;
retaining analysis result information including the parsing result candidates, the semantic analysis result candidates, and correspondence relations between the parsing result candidates and the semantic analysis result candidates;
determining a correct semantic analysis result by use of user interface for presenting the semantic analysis result candidates to a user so as to allow the user to select the correct semantic analysis result;
determining a parsing result based on the determined semantic analysis result and the analysis result information retained;
performing tagging with tags indicating syntactic information upon the retained sentence based on the determined parsing result; and
outputting the sentence, which the tags indicating the syntactic information is tagged with.

17. A machine translation method comprising:
performing parsing processing on a sentence, which is written in a first natural language to output parsing result candidates;
performing semantic analysis processing on the sentence to output semantic analysis result candidates;
retaining analysis result information including the parsing result candidates, the semantic analysis result candidates, and correspondence relations between the parsing result candidates and the semantic analysis result candidates;
determining a correct semantic analysis result by use of user interface for presenting the semantic analysis result candidates to a user so as to allow the user to select the correct semantic analysis result;
determining a parsing result based on the determined semantic analysis result and the analysis result information retained; and
translating the sentence, which is written in the first natural language, into a sentence, which is written in a second natural language.

18. A medium in which a program is recorded, the program causing a computer to conduct mechanical translation comprising:
performing parsing processing on a sentence, which is written in a first natural language to output parsing result candidates;
performing semantic analysis processing on the sentence to output semantic analysis result candidates;
retaining analysis result information including the parsing result candidates, the semantic analysis result candidates, and correspondence relations between the parsing result candidates and the semantic analysis result candidates;
determining a correct semantic analysis result by use of user interface for presenting the semantic analysis result candidates to a user so as to allow the user to select the correct semantic analysis result;
determining a parsing result based on the determined semantic analysis result and the analysis result information retained; and
translating the sentence, which is written in the first natural language, into a sentence, which is written in a second natural language.

19. A sentence analysis method comprising:
determining a semantic analysis result by allowing a user to make a selection from a plurality of semantic analysis result candidates produced from a sentence for parsing so as to disambiguate at least one predicate, case frame, case element, and modification destination of non-case element; and
determining a parsing result based on the determined semantic analysis result and the plurality of semantic analysis result candidates.

20. A medium in which a program is recorded, the program causing a computer to conduct a sentence analysis comprising:
determining a semantic analysis result by allowing a user to make a selection from a plurality of semantic analysis result candidates produced from a sentence for parsing so as to disambiguate at least one of predicate, case frame, case element, and modification destination of non-case element; and
determining a parsing result based on the determined semantic analysis result and the plurality of semantic analysis result candidates.
